(19) United States
(12) Patent Application Publication
(10) Pub. No.: US 2025/0294140 A1
(43) Pub. Date: Sep. 18, 2025

(54) CODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Xue HAO, Dongguan (CN); Ming LI, Dongguan (CN)

(21) Appl. No.: 19/173,973

(22) Filed: Apr. 9, 2025

Related U.S. Application Data
(63) Continuation of application No. PCT/CN2022/125208, filed on Oct. 13, 2022.

(51) Int. Cl. H04N 19/11; H04N 19/159; H04N 19/176; H04N 19/52; H04N 19/70

(52) U.S. Cl. CPC H04N 19/11; H04N 19/159; H04N 19/176; H04N 19/52; H04N 19/70

(57) ABSTRACT

Embodiments of this application disclose a coding method, a bitstream, an encoder, a decoder, and a storage medium. The method includes: determining a first color component block of a current block; in a case that a prediction mode of the first color component block is an IBC mode, determining a first block vector parameter of the first color component block; determining a target block vector parameter of a second color component of the current block based on the first block vector parameter of the first color component block; and performing IBC extension mode-based prediction on the second color component of the current block by using the target block vector parameter, to determine a predicted value for the second color component of the current block.

### CROSS-REFERENCE TO RELATED APPLICATIONS

This application is a continuation of International Application No. PCT/CN2022/125208, filed on Oct. 13, 2022, the disclosure of which is hereby incorporated by reference in its entirety.

### TECHNICAL FIELD

Embodiments of this application relate to the field of video coding technologies, and in particular, to a coding method, a bitstream, an encoder, a decoder, and a storage medium.

### BACKGROUND

With an increasing demand for video display quality, new video applications such as high-definition and ultra-high-definition videos have emerged. The Joint Video Exploration Team (JVET) formed by the International Organization for Standardization ISO/IEC and the ITU-T developed the video coding standard H.266/versatile video coding (VVC). In this standard, intra block copy (IBC) is a block-level encoding mode provided in VVC for video sequences of screen content types.

In related technologies, for a direct mode (DM), if an IBC mode is used for a luma block, a chroma prediction mode is not configured appropriately, resulting in inaccurate chroma prediction for a current block and reducing of encoding efficiency.

### SUMMARY

Embodiments of this application provide a coding method, a bitstream, an encoder, a decoder, and a storage medium, which can reduce a code rate, improve coding efficiency, and thus improve coding performance.

Technical solutions in embodiments of this application may be implemented as follows.

According to a first aspect, an embodiment of this application provides a method for determining a prediction mode. The method includes:
determining a first color component block of a current block;
in a case that a prediction mode of the first color component block is an IBC mode, determining a first block vector parameter of the first color component block;
determining a target block vector parameter of a second color component of the current block based on the first block vector parameter of the first color component block; and
performing IBC extension mode-based prediction on the second color component of the current block by using the target block vector parameter, to determine a predicted value for the second color component of the current block.

According to a second aspect, an embodiment of this application provides a decoding method. The method includes:
determining a value for first syntax element identity information;
in a case that the first syntax element identity information indicates that an IBC extension mode is enabled for a second color component of a current block, decoding a bitstream to determine a value for second syntax element identity information; and
in a case that the second syntax element identity information indicates that a target prediction mode is used for the second color component of the current block, performing intra prediction on the second color component of the current block using the target prediction mode, to determine a predicted value for the second color component of the current block.

According to a third aspect, an embodiment of this application provides an encoding method. The encoding method includes:
in a case that a prediction mode of a second color component of a current block is a target prediction mode, determining a first color component block of the current block;
in a case that a prediction mode of the first color component block is an IBC mode, determining a first block vector parameter of the first color component block;
determining a target block vector parameter of the second color component of the current block based on the first block vector parameter of the first color component block; and
performing IBC extension mode-based prediction on the second color component of the current block by using the target block vector parameter, to determine a predicted value for the second color component of the current block.

According to a fourth aspect, an embodiment of this application provides a bitstream. The bitstream is generated by encoding information to be encoded, where the information to be encoded includes at least one of:
a target block vector parameter of a current block, a value for first syntax element identity information, a value for second syntax element identity information, a value for third syntax element identity information, a value for fourth syntax element identity information, a value for fifth syntax element identity information, or a value for sixth syntax element identity information.

According to a fifth aspect, an embodiment of this application provides an encoder. The encoder includes a first determining unit and a first prediction unit.

The first determining unit is configured to: in a case that a prediction mode of a second color component of a current block is a target prediction mode, determine a first color component block of the current block; and in a case that a prediction mode of the first color component block is an IBC mode, determine a first block vector parameter of the first color component block; and determine a target block vector parameter of the second color component of the current block based on the first block vector parameter of the first color component block.

The first prediction unit is configured to perform IBC extension mode-baed prediction on the second color component of the current block by using the target block vector parameter, to determine a predicted value for the second color component of the current block.

According to a sixth aspect, an embodiment of this application provides an encoder. The encoder includes a first memory and a first processor.

The first memory is configured to store a computer program runnable on the first processor.

The first processor is configured to run the computer program to execute the method according to the third aspect.

According to a seventh aspect, an embodiment of this application provides a decoder. The decoder includes a second determining unit and a second prediction unit.

The second determining unit is configured to: determine a first color component block of a current block, determine a first block vector parameter of the first color component block in a case that a prediction mode of the first color component block is an IBC mode, and determine a target block vector parameter of a second color component of the current block based on the first block vector parameter of the first color component block.

The second prediction unit is configured to perform IBC extension mode-based prediction on the second color component of the current block by using the target block vector parameter, to determine a predicted value for the second color component of the current block.

According to an eighth aspect, an embodiment of this application provides a decoder. The decoder includes a decoding unit, a second determining unit, and a second prediction unit.

The second determining unit is configured to determine a value for first syntax element identity information.

The decoding unit is configured to: in a case that the first syntax element identity information indicates that an IBC extension mode is enabled for a second color component of a current block, decode a bitstream to determine a value for second syntax element identity information.

The second prediction unit is configured to: in a case that the second syntax element identity information indicates that a target prediction mode is used for the second color component of the current block, perform intra prediction on the second color component of the current block using the target prediction mode, to determine a predicted value for the second color component of the current block.

According to a ninth aspect, an embodiment of this application provides a decoder. The decoder includes a second memory and a second processor.

The second memory is configured to store a computer program runnable on the second processor.

The second processor is configured to run the computer program to execute the method according to the first aspect or the second aspect.

According to a tenth aspect, an embodiment of this application provides a computer-readable storage medium, where the computer-readable storage medium stores a computer program, and the computer program is executed to implement the method according to the first aspect, the method according to the second aspect, or the method according to the third aspect.

The embodiments of this application provide a coding method, a bitstream, an encoder, a decoder, and a storage medium. On an encoding side, in a case that a prediction mode of a second color component of a current block is a target prediction mode, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block. On a decoding side, a value for first syntax element identity information is determined; in a case that the first syntax element identity information indicates that an IBC extension mode is enabled for a second color component of a current block, a bitstream is decoded to determine a value for second syntax element identity information; in a case that the second syntax element identity information indicates that a target prediction mode is used for the second color component of the current block, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block.

### BRIEF DESCRIPTION OF DRAWINGS

FIG. 1 is a schematic flowchart of acquisition a reconstructed sample using an IBC mode.

FIG. 2 is a schematic diagram of location distribution of neighboring blocks according to an embodiment of this application.

FIG. 3 is a schematic diagram of a location relationship between a luma CU and a chroma CU according to an embodiment of this application.

FIG. 4A is a schematic block diagram of a structure of an encoder according to an embodiment of this application.

FIG. 4B is a schematic block diagram of a structure of a decoder according to an embodiment of this application.

FIG. 5 is a schematic diagram of a network architecture of a coding system according to an embodiment of this application.

FIG. 6 is a schematic flowchart of a method for determining a prediction mode according to an embodiment of this application.

FIG. 7 is a schematic diagram of another location relationship between a luma CU and a chroma CU according to an embodiment of this application.

FIG. 8 is a schematic diagram of still another location relationship between a luma CU and a chroma CU according to an embodiment of this application.

FIG. 9 is a schematic diagram of still yet another location relationship between a luma CU and a chroma CU according to an embodiment of this application.

FIG. 10 is a schematic structural diagram showing whether an offset location does not overlap a current block according to an embodiment of this application.

FIG. 11 is a schematic structural diagram showing whether an offset location exceeds an IBC available region according to an embodiment of this application.

FIG. 12 is a schematic structural diagram of determining an optimal chroma BV parameter according to an embodiment of this application.

FIG. 13 is a schematic structural diagram of performing block copying using an IBC extension mode according to an embodiment of this application.

FIG. 14 is a detailed schematic flowchart of a method for determining a prediction mode according to an embodiment of this application.

FIG. 15 is a detailed schematic flowchart of another method for determining a prediction mode according to an embodiment of this application.

FIG. 16 is a schematic flowchart of a decoding method according to an embodiment of this application.

FIG. 17 is a schematic flowchart of an encoding method according to an embodiment of this application.

FIG. 18 is a schematic diagram of a structure of an encoder according to an embodiment of this application.

FIG. 19 is a schematic diagram of a structure of specific hardware of an encoder according to an embodiment of this application.

FIG. 20 is a schematic diagram of a structure of a decoder according to an embodiment of this application.

FIG. 21 is a schematic diagram of a structure of another decoder according to an embodiment of this application.

FIG. 22 is a schematic diagram of a structure of specific hardware of a decoder according to an embodiment of this application.

FIG. 23 is a schematic diagram of a structure of a coding system according to an embodiment of this application.

### DESCRIPTION OF EMBODIMENTS

To understand features and technical solutions of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, the term “some embodiments” describe a subset of all possible embodiments, but it may be understood that “some embodiments” may be the same subset or different subsets of all possible embodiments and may be combined with each other without a conflict. It should also be noted that the term “first/second/third” used in embodiments of this application is merely used to distinguish between similar objects and does not represent a specific order of objects. It may be understood that “first/second/third” may be interchanged if allowed, so that the embodiments of this application described herein may be implemented in a sequence other than the sequence illustrated or described herein.

The nouns and terms used in embodiments of this application are described before providing a more detailed description of embodiments of this application, and the nouns and terms used in embodiments of this application are applicable to the following explanations:
Coding block (CB);
Intra block copy (IBC);
Screen content coding (SCC);
Block matching (BM);
Coding unit (CU);
Block vector (BV);
Motion vector (MV);
Direct block vector (DBV);
Advanced motion vector prediction (IBC Advanced Motion Vector Prediction, AMVP);
Cross-component linear model prediction (CCLM);
Merge mode;
Planar mode;
H.266/Versatile video coding (VVC);
Reference software test platform of VVC (VVC Test Model, VTM).

It may be understood that, in video images, a coding block is generally represented by a first color component, a second color component, and a third color component. The three color components are a luma component, a blue chroma component, and a red chroma component, respectively. Specifically, the luma component is generally denoted by a symbol Y, the blue chroma component is generally denoted by a symbol Cb or U, and the red chroma component is generally denoted by a symbol Cr or V. In this way, a video image may be represented in a YCbCr format or a YUV format.

It may also be understood that IBC is an extension tool for encoding video sequences of a screen content type in VVC. IBC significantly improves encoding efficiency of screen content sequences. Specifically, IBC is a block-level encoding mode. Similar to the inter-frame technique, an encoding side performs a motion search, specifically finding, through block matching, an optimal block vector (also referred to as a motion vector) for each CU. A block vector is a vector that points from a current block to a reference block. IBC differs from the inter-frame technique in that an optimal IBC block vector is obtained by searching within a reconstructed region of a frame (that is, a frame being currently encoded) where a current block is located, while an inter-frame motion vector is obtained by searching within a reference frame neighboring in time domain to a frame being currently encoded.

In H.266/VVC, a specific process of acquiring reconstructed pixels of a current block in the IBC mode may include: deriving a block vector, deriving a predicted sample using the block vector, deriving a residual sample, and deriving a reconstructed sample using the predicted sample and the residual sample.

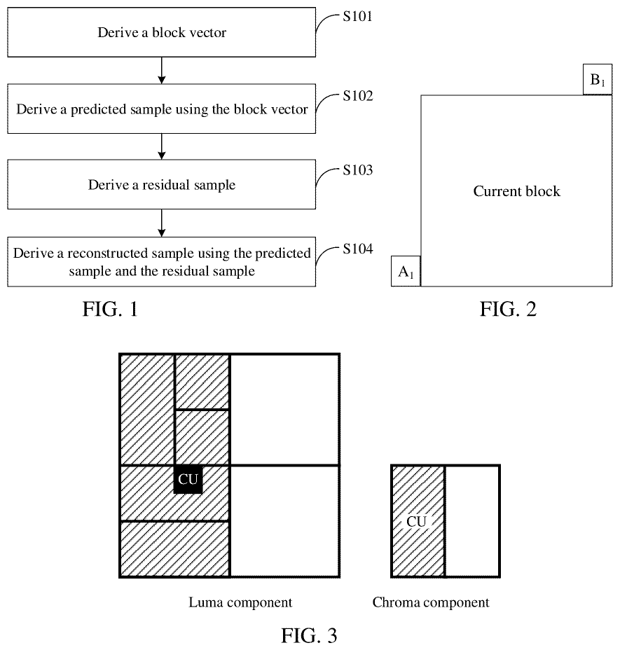

In a specific implementation, a process of acquiring a reconstructed sample in the IBC mode is illustrated in FIG. 1. The process may include S101 to S104.

In S101, a block vector is derived.

For a luma component, an input includes: a luma location (xCb, yCb) specifying a location of a top-left sample of a current block relative to a top-left luma sample of a current image; a variable cbWidth specifying a width of the current block in luma samples; and a variable cbHeight specifying a height of the current block in luma samples. An output includes: a luma block vector (Block Vector Luma, bvL). It should be noted that a current block including a luma sample may also be referred to as a “luma block”.

Here, the IBC mode is classified into an IBC merge mode and an IBC AMVP mode. During derivation of bvL, an IBC block vector candidate list bvCandList needs to be established. A process of establishing an IBC merge list is described in detail below. A process of establishing an IBC AMVP list is the same as the process of establishing the IBC merge list, but a maximum quantity of candidates differs between the IBC AMVP list and the IBC merge list.

In step 1, when IsGt4by4 is TRUE (the variable IsGt4by4 is TRUE when a product of a width and a height of the luma block is greater than 16), a derivation process for spatial block vector candidates from neighboring coding units as specified in the decoding specification is invoked by using the luma block location (xCb, yCb), the width of the luma block (cbWidth), and the height of the luma block (cbHeight) as inputs, to output availability flags availableFlagA₁, availableFlagB₁, and block vectors bvA₁ and bvB₁. A relative relationship between locations of neighboring blocks where A₁ and B₁ are located as well as a location of the current block are shown in FIG. 2.

In step 2, when IsGt4by4 is TRUE, for construction of a block vector candidate list bvCandList, pseudocode is as follows:

i = 0
if( availableFlagA₁ ) bvCandList [i++] = bvA₁
if( availableFlagB₁ )
bvCandList [i++] = bvB₁

In step 3, a variable numCurrCand (a quantity of candidates currently obtained) is derived as follows.

If IsGt4by4 is TRUE, numCurrCand is set to be equal to a quantity of candidates in bvCandList; otherwise, numCurrCand is set to 0.

In step 4, when numCurrCand is less than MaxNumIbcMergeCand (a maximum quantity of candidates in the merge mode) and NumHmvpIbcCand (a maximum quantity of historical optimal block vector Hmvp candidates in the IBC mode) is greater than 0, a derivation process of IBC history-based block vector candidates as specified in the decoding specification is invoked by using bvCandList and numCurrCand as inputs, and modified bvCandList and numCurrCand as outputs.

In step 5, when numCurrCand is less than MaxNumIbcMergeCand, the following is applicable until numCurrCand is equal to MaxNumIbcMergeCand:
bvCandList[numCurrCand][0] is set to be equal to 0 (a horizontal component of the BV);
bvCandList[numCurrCand][1] is set to be equal to 0 (a vertical component of the BV); and
NumCurrCand is increased by 1.

In this way, the block vector candidate list bvCandList is established, and a candidate index bvIdx is derived in the following manner. general_merge_flag indicates whether the IBC merge mode is used:

bvIdx=general_merge_flag[xCb][yCb]?merge_idx[xCb][yCb]:mvp_l0_flag[xCb][yCb]

In this way, a specific bvL may be obtained based on the index bvIdx and the block vector candidate list bvCandList:

bvL[0]=bvCandList[bvIdx][0];

bvL[1]=bvCandList[bvIdx][1].

For the IBC AMVP mode, a specific bvL, that is, a predicted bvL, may be obtained based on the index bvIdx and the block vector candidate list bvCandList. However, a real bvL may be obtained by adding a block vector difference (BVD). A specific process is as follows.

In step 1, a horizontal component and a vertical component of the BVD are obtained. MvdL0 represents a forward motion vector difference. The horizontal component of the BVD is represented by bvd[0], and the vertical component of the BVD is represented by bvd[1]. Details are as follows:

bvd[0]=MvdL0[xCb][yCb][0];

bvd[1]=MvdL0[xCb][yCb][1].

In step 2, the predicted bvL obtained above is rounded. A right shift parameter AmvrShift is for rounding, and a left shift parameter AmvrShift is for resolution increase. Details are as follows:

$$Offset = ( AmvrShift == 0 ) ? 0 : ( ( 1 << ( AmvrShift - 1 ) ) - 1 ) ;$$

$$bvL [ 0 ] = Sign ( bvL [ 0 ] ) * ( ( ( Abs ( bvL [ 0 ] ) + offset ) >> AmvrShift ) << AmvrShift ) ;$$

$$bvL [ 1 ] = Sign ( bvL [ 1 ] ) * ( ( ( Abs ( bvL [ 1 ] ) + offset ) >> AmvrShift ) << AmvrShift ) .$$

In step 3, a range of the real bvL needs to be controlled between −2¹⁷ and 2¹⁷−1. A specific derivation process is as follows:

$$u [ 0 ] = ( bvL [ 0 ] + bvd [ 0 ] + {2}^{18} ) \% {2}^{18} ;$$

$$bvL [ 0 ] = ( u [ 0 ] > = {2}^{17} ) ? ( u [ 0 ] - {2}^{18} ) : u [ 0 ] ;$$

$$u [ 1 ] = ( bvL [ 1 ] + bvd [ 1 ] + {2}^{18} ) \% {2}^{18} ;$$

$$bvL [ 1 ] = ( u [ 1 ] > = {2}^{17} ) ? ( u [ 1 ] - {2}^{18} ) : u [ 1 ] .$$

For a chroma component, if dual-tree partitioning is used, the IBC mode is not used for the chroma component. If single-tree partitioning is used, it is necessary to derive a BV of the chroma component.

An input includes: luma BvL ( 1/16 pixel accuracy). An output includes: a chroma block vector (Block Vector Chroma, bvC) ( 1/32 pixel accuracy). A specific derivation process is as follows:

$$bvC [ 0 ] = ( ( bvL [ 0 ] >> ( 3 + SubWidthC ) ) * 32 ) ;$$

$$bvC [ 1 ] = ( ( bvL [ 1 ] >> ( 3 + SubHeightC ) ) * 32 ) .$$

In S102, a predicted sample is derived using the block vector.

Here, an input includes: a luma location (xCb, yCb) specifying a location of a top-left sample of a current block relative to a top-left luma sample of a current image; a variable cbWidth specifying a width of the current block in luma samples; a variable cbHeight specifying a height of the current block in luma samples; a block vector BV; and a variable cIdx specifying a color component index of the current block. An output includes: an array of predicted samples predSamples.

A specific derivation process for a predicted sample is as follows.

When cIdx is equal to 0, it indicates a luma component. For x=xCb . . . xCb+cbWidth−1 and y=yCb . . . yCb+cbHeight−1:

$$xVb = ( x + ( bv [ 0 ] >> 4 ) ) \& ( IbcBufWidthY - 1 ) ;$$

$$yVb = ( y + ( bv [ 1 ] >> 4 ) ) \& ( CbtSizeY - 1 ) ;$$

$$predSamples [ x ] [ y ] = ibcVirBuf [ 0 ] [ xVb ] [ yVb ] .$$

IbcBufWidthY represents a width of luma pixels of a reconstruction buffer unit (buffer) stored for IBC, CtbSizeY represents a size of a CTU (Coding Tree Unit), and ibcVirBuf represents reconstructed pixels stored for IBC.

When cIdx is not equal to 0, it indicates a chroma component. For

x=xCb/SubWidthC . . . xCb/SubWidthC+cbWidth/SubWidthC−1 and

y=yCb/SubHeightC . . . yCb/SubHeightC+cbHeight/SubHeightC−1:

$$xVb = ( x + ( bv [ 0 ] >> 5 ) ) \& ( IbcBufWidthC - 1 ) ;$$

$$yVb = ( y + ( bv [ 1 ] >> 5 ) ) \& ( ( CbtSizeY / subHeightC ) - 1 ) ;$$

$$predSamples [ x ] [ y ] = ibcVirBuf [ cIdx ] [ xVb ] [ yVb ] .$$

Variables SubWidthC and SubHeightC depend on a chroma sampling format specified through sps_chroma_format_idc, and specific correspondences are shown in Table 1.

TABLE 1

| | Color | | |
|---|---|---|---|
| | sampling | | |
| sps_chroma_format_idc | format | SubWidthC | SubHeightC |
| 0 | Monochrome | 1 | 1 |
| 1 | 4:2:0 | 2 | 2 |
| 2 | 4:2:2 | 2 | 1 |
| 3 | 4:4:4 | 1 | 1 |

In S103, a residual sample is derived.

For the residual sample, a residual decoding process as specified in the decoding specification may be invoked.

In S104, a reconstructed sample is derived using the predicted sample and the residual sample.

For the reconstructed sample (that is, reconstructed pixel values), an image reconstruction process for a specified color component as specified in the decoding specification may be invoked.

In another specific implementation, for a derivation process of a chroma prediction mode in H.266/VVC, an input includes: a luma location (xCb, yCb) specifying a location of a top-left sample of a current block relative to a top-left luma sample of a current image; a variable cbWidth specifying a width of the current block in luma samples; a variable cbHeight specifying a height of the current block in luma samples; and a variable treeType specifying whether single-tree partitioning or dual-tree partitioning is used. An output includes: a chroma intra prediction mode flag IntraPredModeC[xCb][yCb] and an MIP chroma direct mode flag MipChromaDirectFlag[xCb][yCb].

If treeType is equal to SINGLE_TREE, that is, single-tree partitioning is used, sps_chroma_format_idc is equal to 3, that is, a 4:4:4 format is used, intra_chroma_pred_mode is equal to 4, and IntraMipFlag[xCb][yCb] is equal to 1, that is, a prediction mode corresponding to a co-located luma center block is the MIP mode, then:

(1) The MIP chroma direct mode flag MipChromaDirectFlag[xCb][yCb] is set to be equal to 1, that is, the MIP mode for luma is used for chroma.

(2) The chroma intra prediction mode flag IntraPredModeC[xCb][yCb] is set to be equal to IntraPredModeY[xCb][yCb].

Otherwise:

(1) The MIP chroma direct mode flag MipChromaDirectFlag[xCb][yCb] is set to be equal to 0.

(2) The corresponding luma intra prediction mode lumaIntraPredMode is derived as follows:

If IntraMipFlag[xCb+cbWidth/2][yCb+cbHeight/2] is equal to 1, lumaIntraPredMode is set to be equal to INTRA_PLANAR.

Otherwise, if CuPredMode[0][xCb+cbWidth/2][yCb+cbHeight/2] is equal to MODE_IBC or MODE_PLT, lumaIntraPredMode is set to be equal to INTRA_DC.

Otherwise, lumaIntraPredMode is set to be equal to IntraPredModeY[xCb+cbWidth/2][yCb+cbHeight/2].

(3) Derivation of the chroma intra prediction mode IntraPredModeC[xCb][yCb] is as follows:

If cu_act_enabled_flag[xCb][yCb] is equal to 1, the chroma intra prediction mode IntraPredModeC[xCb][yCb] is set to be equal to lumaIntraPredMode.

Otherwise:

If BdpcmFlag[xCb][yCb][1] is equal to 1, IntraPredModeC[xCb][yCb] is set to be equal to BdpcmDir[xCb][yCb][1]?INTRA_ANGULAR50:INTRA_ANGULAR18.

Otherwise, en_act_enabled_flag[xCb][yCb] is equal to 0 and BdpcmFlag[xCb][yCb][1] is equal to 0, the chroma ultra prediction mode IntraPredModeC[xCb][yCb] is derived using cclm_mode_flag, cclm_mode_idx, intra_chroma_pred_mode, and lumaIntraPredMode as specified in Table 2.

TABLE 2

| | | | lumaIntraPredMode | | | | |
|---|---|---|---|---|---|---|---|
| | | | | | | | X |
| cclm_mode_flag | cclm_mode_idx | intra_chroma_pred_mode | 0 | 50 | 18 | 1 | (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

When sps_chroma_format_idc is equal to 2, the chroma intra prediction mode Y may be derived using the chroma intra prediction mode X in Table 2. For details, reference is made to Table 3, which shows specification of a process of mapping from the mode X to the mode Y Then, the chroma intra prediction mode X is set to be equal to the chroma intra prediction mode Y.

TABLE 3

| mode X | 0 | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|---|
| mode Y | 0 | 1 | 61 | 62 | 63 | 64 | 65 | 66 | 2 | 3 | 5 | 6 | 8 | 10 | 12 | 13 | 14 |
| mode X | 18 | 19 | 20 | 21 | 22 | 23 | 24 | 25 | 26 | 27 | 28 | 29 | 30 | 31 | 32 | 33 | 34 |
| mode Y | 18 | 20 | 22 | 23 | 24 | 26 | 28 | 30 | 31 | 33 | 34 | 35 | 36 | 37 | 38 | 39 | 40 |
| mode X | 36 | 37 | 38 | 39 | 40 | 41 | 42 | 43 | 44 | 45 | 46 | 47 | 48 | 49 | 50 | 51 | 52 |
| mode Y | 41 | 42 | 43 | 43 | 44 | 44 | 45 | 45 | 46 | 47 | 48 | 48 | 49 | 49 | 50 | 51 | 51 |

| mode X | 54 | 55 | 56 | 57 | 58 | 59 | 60 | 61 | 62 | 63 | 64 | 65 | 66 |
|---|---|---|---|---|---|---|---|---|---|---|---|---|---|
| mode Y | 52 | 53 | 54 | 55 | 55 | 56 | 56 | 57 | 57 | 58 | 59 | 59 | 60 |

In still another specific implementation, the DM mode refers to directly using information about a luma prediction mode for a corresponding location:

When dual-tree partitioning is used for an I-frame, a luma component and a chroma component are each allowed to use an independent block partitioning structure. In this case, a luma component at a location corresponding to a chroma CU may include a plurality of luma CUs, as shown in FIG. 3. In H.266/VVC, a chroma CU inherits an intra prediction mode for a CU at a center location of a respective luma block, that is, intra_chroma_pred_mode is equal to 4.

In the DM mode, a location of a CU used is specifically described as follows:

a luma location (xCb, yCb) specifying a location of a top-left luma sample, in a luma region corresponding to a current block, relative to a top-left luma sample of a current image; a variable cbWidth specifying a width of the current block in luma samples; and a variable cbHeight, specifying a height of the current block in luma samples.

A location relationship between a current chroma CU and a corresponding luma region is shown in FIG. 3, and a location of a luma pixel at the center of the luma region corresponding to the current chroma CU is described as follows. In which, xCenter represents a horizontal coordinate location, yCenter represents a vertical coordinate location, and a CU including the pixel location is a CU at a center location of a luma block corresponding to the chroma CU.

$$xCenter = xCb + cbWidth >> 1 ,$$

$$yCenter = yCb + cbHeight >> 1.$$

In still another specific implementation, a decoding process for chroma prediction in H.266/VVC is shown in Table 4. In addition, for a syntax element Value of intra_chroma_pred_mode, a corresponding binary mapping table is shown in Table 5. For different syntax elements (such as cclm_mode_flag, cclm_mode_idx, and intra_chroma_pred_mode), an encoding method used for each bit to be encoded is specifically shown in Table 6.

TABLE 4

| | |
|---|---|
| if( !cu_act_enabled_flag ) { | |
| if( cbWidth / SubWidthC <= MaxTsSize && | |
| cbHeight / SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

TABLE 5

| Value of intra_chroma_pred_mode | Bin string |
|---|---|
| 0 | 100 |
| 1 | 101 |
| 2 | 110 |
| 3 | 111 |
| 4 | 0 |

TABLE 6

| Syntax element | binIdx | | | | | |
|---|---|---|---|---|---|---|
| (Syntax element) | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

where binIdx represents a quantity of bits. If binIdx = 0, it indicates the 0^{th} bit. If binIdx = 1, it indicates the first bit. In addition, bypass represents a bypass mode and na represents no processing.

In related technologies, under dual-tree partitioning: For the DM mode, if the IBC mode is used for the corresponding luma block, an obtained chroma prediction mode is the DC mode, resulting in reducing of encoding efficiency. For chroma prediction, if prediction is performed using the fixed DC mode, resulting in that all predicted pixels having a same value, thus failing to express chroma texture feature of the current block. In addition, the chroma prediction fails to utilize information about a co-located luma block. Furthermore, no prediction algorithm similar to block copying in IBC is applied, resulting in that video sequences similar to screen content cannot be effectively compressed. In short, the current chroma prediction mode is monotonous, resulting in inaccurate chroma prediction for the current block and reducing of encoding efficiency.

In view of this, an embodiment of this application provides an encoding method. According to this method, in a case that a prediction mode of a second color component of a current block is a target prediction mode, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block.

An embodiment of this application further provides a decoding method. In this method, a value for first syntax element identity information is determined; in a case that the first syntax element identity information indicates that an IBC extension mode is enabled for a second color component of a current block, a bitstream is decoded to determine a value for second syntax element identity information; in a case that the second syntax element identity information indicates that a target prediction mode is used for the second color component of the current block, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block.

In this way, in a process of determining a chroma prediction mode based on a luma prediction mode, if a prediction mode of a luma block corresponding to a current block is an IBC mode, a target block vector parameter to be applied to a chroma component may be determined based on a block vector parameter of the luma block, and IBC extension mode-based prediction is performed on the chroma component by using the target block vector parameter, to determine a chroma predicted value for the current block, so that a problem of monotony in chroma prediction is resolved, the IBC mode is implicitly applied into chroma prediction, and related information of the co-located luma block is fully utilized, thereby improving accuracy of chroma prediction, reducing a code rate, improving coding efficiency, and thus improving coding performance.

The following describes embodiments of this application in detail with reference to the drawings.

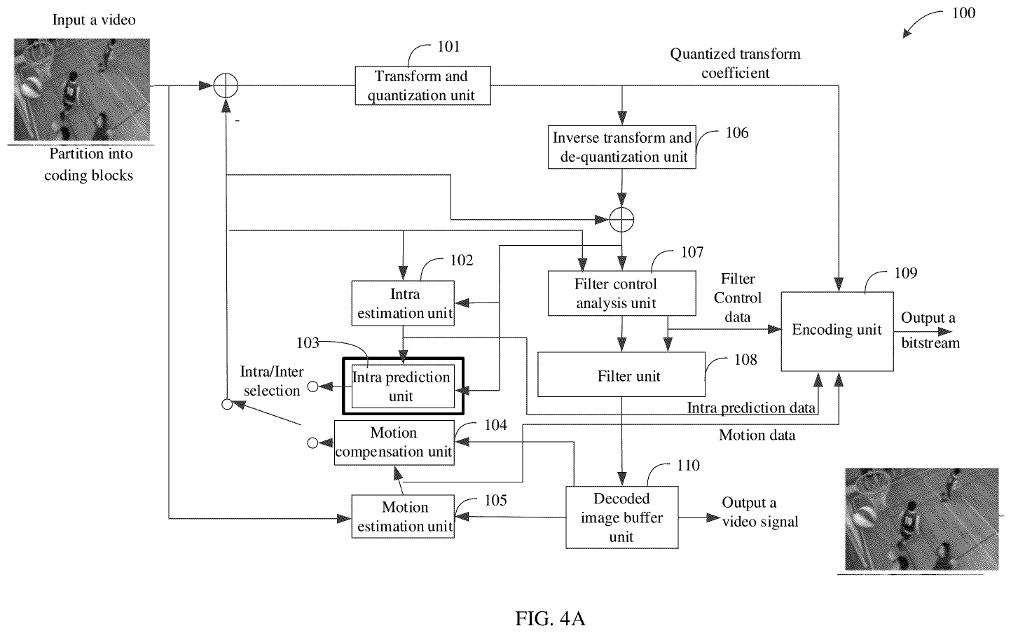

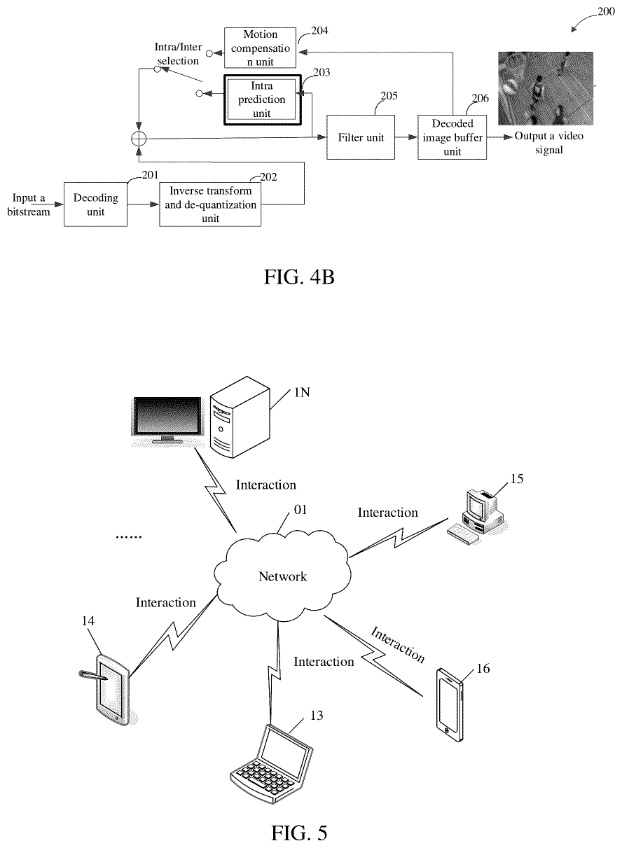

Referring to FIG. 4A, which is a schematic block diagram of a structure of an encoder according to an embodiment of this application. As shown in FIG. 4A, an encoder (specifically, a “video encoder”) 100 may include a transform and quantization unit 101, an intra estimation unit 102, an intra prediction unit 103, a motion compensation unit 104, a motion estimation unit 105, an inverse transform and de-quantization unit 106, a filter control analysis unit 107, a filtering unit 108, an encoding unit 109, a decoded image buffer unit 110, and the like. The filtering unit 108 may implement deblocking filtering and sample adaptive offset (SAO) filtering. The encoding unit 109 may implement header information encoding and context-based adaptive binary arithmetic encoding (CABAC). An input original video signal may be subjected to coding tree unit (CTU) partitioning to obtain a video coding block, residual pixel information obtained after intra prediction or inter prediction is transformed by the transform and quantization unit 101 for the video coding block, which includes converting the residual information from pixel domain to transform domain, and quantizing obtained transform coefficients, to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used for encoding the video coding block. The motion compensation unit 104 and the motion estimation unit 105 are configured to perform inter prediction encoding on the received video coding block relative to one or more blocks in one or more reference frames, to provide time prediction information. Motion estimation performed by the motion estimation unit 105 is a process of generating a motion vector, which may estimate motion of the video coding block. Then, the motion compensation unit 104 performs motion compensation based on the motion vector determined by the motion estimation unit 105. After determining the intra prediction mode, the intra prediction unit 103 is further configured to provide selected intra prediction data to the encoding unit 109, while the motion estimation unit 105 transmits the computed motion vector data to the encoding unit 109. In addition, the inverse transform and de-quantization unit 106 is configured to reconstruct the video coding block, specifically to reconstruct a residual block in pixel domain. The reconstructed residual block is then processed by the filter control analysis unit 107 and the filtering unit 108 to remove blocking artifacts. The reconstructed residual block is subsequently added to a predictive block in a frame in the decoded image buffer unit 110 to generate a reconstructed video coding block. The encoding unit 109 is configured to encode various encoding parameters and quantized transform coefficients. In the CABAC-based encoding algorithm, contextual content, which may be based on neighboring coding blocks, may be used to encode information that indicates the determined intra prediction mode, and output a bitstream for the video signal. The decoded image buffer unit 110 is configured to store the reconstructed video coding block for prediction reference. As video image encoding proceeds, new reconstructed video coding blocks are continuously generated, and these reconstructed video coding blocks may be all stored in the decoded image buffer unit 110.

Reference is made to FIG. 4B, which is a schematic block diagram of a structure of a decoder according to an embodiment of this application. As shown in FIG. 4B, the decoder (specifically, a “video decoder”) 200 includes a decoding unit 201, an inverse transform and de-quantization unit 202, an intra prediction unit 203, a motion compensation unit 204, a filtering unit 205, a decoded image buffer unit 206, and the like. The decoding unit 201 may implement header information decoding and CABAC-based decoding. The filtering unit 205 may implement deblocking filtering and SAO filtering. After the inputted video signal is encoded as shown in FIG. 4A, a bitstream for the video signal is outputted. The bitstream is inputted into the decoder 200, and is first processed by the decoding unit 201 to obtain decoded transform coefficients. The transform coefficients are processed by the inverse transform and de-quantization unit 202 to generate a residual block in pixel domain. The intra prediction unit 203 may be configured to generate predicted data for a current video decoding block based on the determined intra prediction mode and data from a previously decoded block of a current frame or picture. The motion compensation unit 204 determines predicted information for the video decoding block by analyzing the motion vector and other associated syntax elements, and generates, using the predicted information, a predictive block for the video decoding block being decoded. A decoded video block is generated by summing the residual block from the inverse transform and de-quantization unit 202 and the predictive block generated by the intra prediction unit 203 or the motion compensation unit 204. The decoded video signal is processed by the filtering unit 205 to remove blocking artifacts, thereby improving video quality. Then, the decoded video block is stored in the decoded image buffer unit 206. The decoded image buffer unit 206 stores a reference image for subsequent intra prediction or motion compensation, and also for output of the video signal, that is, the restored original video signal is obtained.

Further, an embodiment of this application further provides a network architecture of a coding system including an encoder and a decoder. FIG. 5 is a schematic diagram of a network architecture of a coding system according to an embodiment of this application. As shown in FIG. 5, the network architecture includes one or more electronic devices 13 to 1N and a communication network 01. The electronic devices 13 to 1N may perform video interaction with each other through the communication network 01. The electronic devices may be implemented as various types of devices having a video coding function. For example, the electronic devices may include a smartphone, a tablet computer, a personal computer, a personal digital assistant, a navigator, a digital phone, a videophone, a television, a sensing device, a server, and the like, which is not specifically limited in embodiments of this application. Here, the decoder or the encoder described in embodiments of this application may be the electronic device described above.

It should be noted that the method in embodiments of this application is mainly applied to the intra prediction unit 103 part shown in FIG. 4A and the intra prediction unit 203 part shown in FIG. 4B. That is, embodiments of this application may be applied to an encoder, or a decoder, or may even be applied to both an encoder and a decoder, which is not specifically limited in embodiments of this application.

It should also be noted that, when the method is applied to the intra prediction unit 103, the “current block” specifically refers to a block that is to be subjected to intra prediction and then encoded. When the method is applied to the intra prediction unit 203, the “current block” specifically refers to a block that is to be subjected to intra prediction and then decoded.

In an embodiment of this application, reference is made to FIG. 6, which is a schematic flowchart of a method for determining a prediction mode according to an embodiment of this application. As shown in FIG. 6, the method may include S601 to S604.

In S601, a first color component block of a current block is determined.

It should be noted that the method in embodiments of this application may be applied to an encoder or a decoder. In addition, the prediction mode here may specifically refer to an intra prediction mode. Assuming that a first color component is a luma component and a second color component is a chroma component, more specifically, the method here is a method for determining a chroma intra prediction mode.

It should also be noted that, in embodiments of this application, the current block includes at least a first color component and a second color component. For the first color component of the current block, the block in this case may be referred to as a first color component block; and when the first color component is a luma component, the first color component block may also be referred to as a luma block. Similarly, for the second color component of the current block, the block in this case may be referred to as a second color component block; and when the second color component is a chroma component, the second color component block may also be referred to as a chroma block.

It should also be noted that, under dual-tree partitioning, for the DM mode, when a prediction mode of a co-located luma block is the IBC mode, a chroma intra prediction mode for the current block is determined based on the prediction mode of the co-located luma block according to embodiments of this application, thereby solving monotony problem in chroma prediction, and thus improving encoding efficiency.

In some embodiments, the process of determining a first color component block of a current block may include: determining a first color component region co-located with the current block; and determining the first color component block of the current block from a plurality of blocks obtained by partitioning the first color component region.

It should be noted that, in embodiments of this application, the first color component region co-located with the current block may be subjected to block partitioning, such as using a binary tree structure, a ternary tree structure, or a quadtree structure, to obtain a plurality of blocks. Each block may be considered as a CU. The first color component block of the current block may be then determined from the plurality of CUs.

For example, as shown in FIG. 3, a region filled with oblique lines represents a luma region co-located with a chroma CU. The co-located luma region may be partitioned into a plurality of blocks. A block at a center location may be selected from the plurality of blocks as a luma block of the current block. For example, a black filled block in FIG. 3 is the luma block of the current block.

Further, in some embodiments, the process of determining the first color component block of the current block from a plurality of blocks obtained by partitioning the first color component region may include: selecting a target block from the plurality of blocks obtained by partitioning the first color component region, as the first color component block of the current block.

The target block may be a block at any location. In a specific embodiment, a block at a center location in the first color component region is selected as the target block, or a block at a top-left corner in the first color component region is selected as the target block, or a block at a bottom-right corner in the first color component region is selected as the target block.

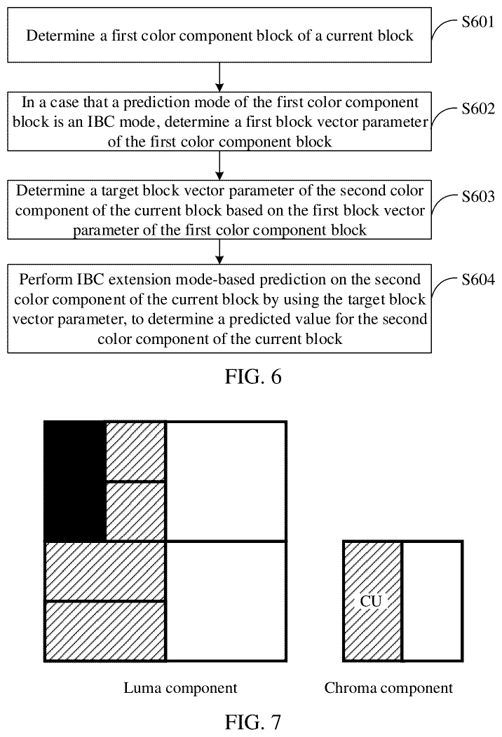

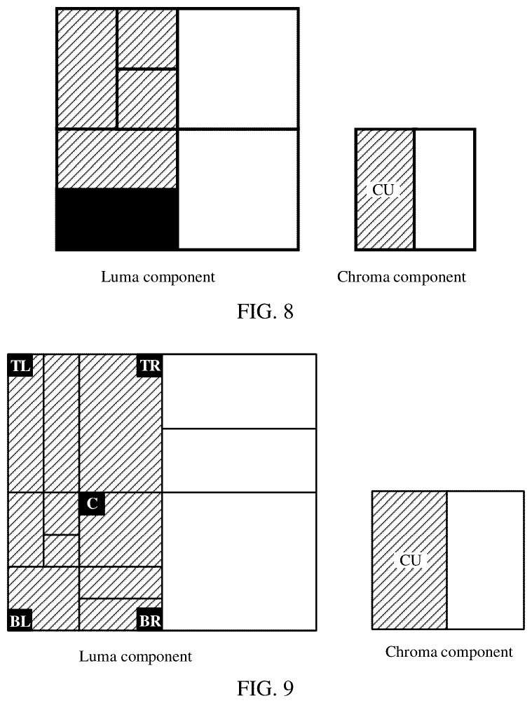

It should be understood that in this embodiment of this application, the target block serving as the first color component block may be a block at any location in the plurality of blocks shown in FIG. 3, for example, a block at a center location in the co-located luma region (the block filled with black) as shown in FIG. 3, a block at a top-left corner in the co-located luma region (the block filled with black) as shown in FIG. 7, a block at a bottom-right corner in the co-located luma region (the block filled with black) as shown in FIG. 8, a block at a top-right corner in the co-located luma region, a block at a bottom-left corner in the co-located luma region, or even a block at a center location in a top-left region, or the like, which is not specifically limited here.

In some embodiments, the process of determining the first color component block of the current block from a plurality of blocks obtained by partitioning the first color component region may include: determining at least one candidate block at a preset location from the plurality of blocks obtained by partitioning the first color component region; and acquiring the at least one candidate block according to a preset order and performing mode determination; and in a case that it is determined that the IBC mode is used for the first candidate block, using the first candidate block as the first color component block of the current block.

It should be understood that, in embodiments of this application, the first color component block may alternatively be determined by performing mode determination on the at least one candidate block at the preset location. For example, as shown in FIG. 9, there are CUs at five luma pixel locations: C, TL, TR, BL, and BR. However, embodiments of this application are not limited to five locations, and there may be a plurality of different locations, and are not limited to the five locations shown in FIG. 9, which is not specifically limited.

It should also be understood that in this embodiment of this application, candidate blocks at the five locations shown in FIG. 9 may be acquired according to a preset order until a candidate block of which the prediction mode is the IBC mode is determined, that is, until it is determined that the prediction mode of the CU at the first luma pixel location is the IBC mode, and the CU at the first luma pixel location is used as the corresponding luma block of the current block.

In addition, in embodiments of this application, the preset order may include, but is not limited to, the following order: C->TL->TR->BL->BR. A derivation process for specific locations of C, TL, TR, BL, BR are as follows.

It is assumed that a location of a co-located luma pixel at a top-left corner of the current block relative to a luma pixel at a top-left corner of an image (that is, a location of the luma pixel TL) is (xCb, yCb), a width of the co-located luma region (that is, the entire region filled with oblique lines of the luma component in FIG. 9) corresponding to the current block is cbWidth, and a height of the co-located luma region is cbHeight.

Coordinate information of a location of the luma pixel C is (xCb+cbWidth/2, yCb+cbHeight/2).

Coordinate information of a location of the luma pixel TL is (xCb, yCb).

Coordinate information of a location of the luma pixel TR is (xCb+cbWidth−1, yCb).

Coordinate information of a location of the luma pixel BL is (xCb, yCb+cbHeight−1).

Coordinate information of a location of the luma pixel BR is (xCb+cbWidth−1, yCb+cbHeight−1).

In this way, the corresponding first color component block of the current block needs to be determined first. When the first color component is a luma component, a luma block (that is, a luma CU) at the corresponding location needs to be determined here.

In S602, in a case that a prediction mode of the first color component block is an IBC mode, a first block vector parameter of the first color component block is determined.

It should be noted that in this embodiment of this application, after the first color component block is determined, it is necessary to determine a prediction mode of the first color component block. If the prediction mode of the first color component block is the IBC mode, it is necessary to further determine the first block vector parameter of the first color component block.

It should be understood that, in embodiments of this application, if the prediction mode of the first color component block is the IBC mode, the first block vector parameter of the first color component block may be acquired. The first block vector parameter represents a vector that points from the current block to a reference block, and the reference block is obtained by searching within a reconstructed region of a frame (i.e., a current image) where the current block is located.

It should also be understood that in embodiments of this application, if there are a plurality of first color component blocks, the first block vector parameter may be obtained by averaging BVs of the plurality of first color component blocks. Therefore, in some embodiments, the process of determining the first color component block of the current block from a plurality of blocks obtained by partitioning the first color component region may include: determining at least one candidate block at a preset location from the plurality of blocks obtained by partitioning the first color component region, and determining the at least one candidate block as the first color component block of the current block.

In a possible implementation, the process of determining a first block vector parameter of the first color component block in a case that a prediction mode of the first color component block is an IBC mode may include: determining at least one target block for which the IBC mode is used from the at least one candidate block, and determining a first block vector parameter of each of the at least one target block; and calculating an average of the first block vector parameters of all of the at least one target block, as the first block vector parameter of the first color component block.

It should be noted that, in embodiments of this application, the first color component block of the current block is not limited to one block here, and may alternatively be composed of a plurality of blocks. When the first color component block consists of a plurality of blocks, prediction modes of the plurality of blocks are all the IBC mode. For example, a plurality of luma CUs in the co-located luma region are first acquired, and then an average of first block vector parameters of the plurality of luma CUs is calculated, as the finally acquired first block vector parameter.

In another possible implementation, the finally acquired first block vector parameter may be determined by selecting an optimal block vector parameter through template matching. Therefore, in some embodiments, the process of determining a first block vector parameter of the first color component block in a case that a prediction mode of the first color component block is an IBC mode may further include: determining at least one target block for which the IBC mode is used from the at least one candidate block; and performing searching on the at least one target block using a template matching manner, to determine an optimal block vector parameter, as the first block vector parameter of the first color component block.

Here, FIG. 9 is still used as an example. For the luma CUs at the five locations C, TL, TR, BL, and BR, when the IBC mode is used for all the five luma CUs, a plurality of luma CUs in the co-located luma region are obtained. Then, the optimal block vector parameter is selected using a template matching manner, as the finally acquired first block vector parameter. Locations of the plurality of luma CUs are not limited to the five locations C, TL, TR, BL, and BR, and may alternatively be other locations, which is not specifically limited in embodiments of this application.

It may be understood that in this embodiment of this application, after the first color component block is determined, it is necessary to determine a prediction mode of the first color component block. If the prediction mode of the first color component block is the IBC mode, the process shown in FIG. 6 continues to be performed, that is, it is necessary to determine the first block vector parameter of the first color component block. If the prediction mode of the first color component block is not the IBC mode, the process shown in FIG. 6 is not performed, and prediction may be performed on the second color component of the current block using a first preset mode, to determine a predicted value for the second color component of the current block.

In some embodiments, the first preset mode includes at least one of: a planar mode, a DM mode, a DC mode, a CCLM mode, or a skip mode, but is not limited thereto.

For example, when the prediction mode of the first color component block is not the IBC mode, the first preset mode may include, but is not limited to, the planar mode, the inter-component prediction mode (such as the CCLM mode), or other angular prediction modes. Then, reference pixels and related parameters are obtained for prediction. In addition, the first preset mode may alternatively be the skip mode, in which prediction on the current block may be skipped.

In S603, a target block vector parameter of the second color component of the current block is determined based on the first block vector parameter of the first color component block.

It should be noted that in embodiments of this application, after the first block vector parameter of the first color component block is determined, it is necessary to further determine the target block vector parameter to be applied to the second color component. In some embodiments, the process of determining a target block vector parameter of the current block based on the first block vector parameter of the first color component block may include: using the first block vector parameter of the first color component block as the target block vector parameter of the current block; or adjusting the first block vector parameter of the first color component block to determine the target block vector parameter of the current block.

It should be understood that in embodiments of this application, for the target block vector parameter of the current block, the first block vector parameter of the first color component block may not be adjusted. In this case, the first block vector parameter of the first color component block may be used as the target block vector parameter of the current block.

It should also be understood that in embodiments of this application, the target block vector parameter of the current block may be obtained by adjusting the first block vector parameter of the first color component block. A manner of adjustment includes, but is not limited to the following two manners.

In a possible implementation, the process of adjusting the first block vector parameter of the first color component block to determine the target block vector parameter of the current block may include: determining a color sampling format for the current block; and performing scaling on the first block vector parameter of the first color component block based on the color sampling format, to determine the target block vector parameter of the current block.

In another possible implementation, the process of adjusting the first block vector parameter of the first color component block to determine the target block vector parameter of the current block may include: performing scaling on the first block vector parameter of the first color component block based on the color sampling format, to obtain an initial block vector parameter of the current block; and modifying the initial block vector parameter of the current block to determine the target block vector parameter of the current block.

It should be understood that in this embodiment of this application, after scaling is performed on the first block vector parameter of the first color component block based on the color sampling format, the target block vector parameter of the current block may be determined based on the obtained initial block vector parameter of the current block.

It should also be understood that in this embodiment of this application, after scaling is performed on the first block vector parameter of the first color component block based on the color sampling format, the obtained initial block vector parameter of the current block may be modified to determine the target block vector parameter of the current block.

It should also be understood that in embodiments of this application, assuming that the first color component is a luma component and the second color component is a chroma component, the luma BV parameters may be adjusted to obtain the target block vector parameter (that is, chroma BV parameters) to be applied to the chroma component, after the corresponding first block vector parameter (that is, luma BV parameters) is obtained. It is assumed that the luma BV parameters are (BVLₕₒᵣ, BVLᵥₑᵣ) and the chroma BV parameters are (BVCₕₒᵣ, BVCᵥₑᵣ), where BVLₕₒᵣ represents a horizontal block vector of the luma BV parameters and BVLᵥₑᵣ represents a vertical block vector of the luma BV parameters, BVCₕₒᵣ represents a horizontal block vector of the chroma BV parameters, and BVCᵥₑᵣ represents a vertical block vector of the chroma BV parameters.

In this way, scaling is performed on the luma BV parameters based on the color sampling format. A mapping relationship between luma BV parameters and scaled chroma BV parameters is shown in Table 7.

TABLE 7

| | Color | | |
|---|---|---|---|
| | sampling | | |
| sps_chroma_format_idc | format | BVCₕₒᵣ | BVCᵥₑᵣ |
| 0 | Monochrome | — | — |
| 1 | 4:2:0 | BVLₕₒᵣ>>1 | BVLᵥₑᵣ>>1 |
| 2 | 4:2:2 | BVLₕₒᵣ>>1 | BVLᵥₑᵣ |
| 3 | 4:4:4 | BVLₕₒᵣ | BVLᵥₑᵣ |

The syntax element sps_chroma_format_ide is used to indicate a type of a color sampling format. The color sampling format here is specifically a chroma sampling format. Here, as the type of the chroma sampling format varies, a corresponding scaling operation also varies.

For example, if a value of sps_chroma_format_idc is 0, it is determined that the chroma sampling format is monochrome. In this case, the process shown in FIG. 6 is not performed, that is, there are no chroma BV parameters (BVCₕₒᵣ, BVCₕₒᵣ). If the value of sps_chroma_format_idc is 1, it is determined that the chroma sampling format is 4:2:0; and in this case, a mapping relationship between the luma BV parameters and the chroma BV parameters is BVCₕₒᵣ=BVLₕₒᵣ>>1, BVCₕₒᵣ=BVLᵥₑᵣ>>1. If the value of sps_chroma_format_idc is 2, it is determined that the chroma sampling format is 4:2:2; and in this case, a mapping relationship between the luma BV parameters and the chroma BV parameters is BVCₕₒᵣ=BVLₕₒᵣ>>1, BVCₕₒᵣ=BVLᵥₑᵣ. If the value of sps_chroma_format_idc is 3, the chroma sampling format is 4:4:4; and in this case, a mapping relationship between the luma BV parameters and the chroma BV parameters is BVCₕₒᵣ=BVLₕₒᵣ, BVCₕₒᵣ=BVLᵥₑᵣ.

For example, after chroma BV parameters scaled based on the chroma sampling format are obtained, the chroma BV parameters may be directly used, or may be modified. The modification here may include, but is not limited to, the following manner: modification is performed using an IntraTMP mode, that is, after the chroma BV parameters are obtained, an offset location is found based on a location of the current block and the obtained chroma BV parameters, a fine search is performed near the offset location using the template matching manner, to determine optimal chroma BV parameters. The optimal chroma BV parameters are used as the finally obtained chroma BV parameters, that is, the target block vector parameter of the current block.

In S604, IBC extension mode-based prediction is performed on the second color component of the current block by using the target block vector parameter, to determine a predicted value for the second color component of the current block.

It should be noted that in embodiments of this application, the IBC extension mode may refer to a new prediction mode introduced in embodiments of this application, which may be represented by INTRA_DBV. In such a prediction mode, prediction is performed on the second color component of the current block based on the determined target block vector parameter, to determine the predicted value for the second color component of the current block.

It should also be noted that in this embodiment of this application, after the target block vector parameter of the current block is obtained, it is necessary to determine whether the target block vector parameter is available, that is, whether the target block vector parameter meets an available condition. In some embodiments, the method may further include: after the target block vector parameter of the current block is determined, determining whether the target block vector parameter meets an available condition; and in a case that the target block vector parameter meets the available condition, performing IBC extension mode-based prediction on the second color component of the current block by using the target block vector parameter, to determine a predicted value for the second color component of the current block.

Specifically, in embodiments of this application, IBC extension mode-based prediction can be performed on the second color component of the current block by using the target block vector parameter only when the target block vector parameter meets the available condition, so as to determine the predicted value for the second color component of the current block.

Further, in some embodiments, whether the target block vector parameter meets the available condition may include at least:
whether an offset location indicated by the target block vector parameter does not exceed an image boundary;
whether an offset location indicated by the target block vector parameter does not overlap the current block;
whether an offset location indicated by the target block vector parameter does not exceed an available region for the IBC mode; and
whether an offset location indicated by the target block vector parameter has been reconstructed.

It should be understood that in this embodiment of this application, only when the conditions above are all met, it can be determined that the target block vector parameter meets the available condition, that is, the target block vector parameter is available. In a specific embodiment, the target block vector parameter meeting the available condition includes at least: an offset location indicated by the target block vector parameter does not exceed an image boundary; an offset location indicated by the target block vector parameter does not overlap the current block; an offset location indicated by the target block vector parameter does not exceed an available region for the IBC mode; and an offset location indicated by the target block vector parameter has been reconstructed.

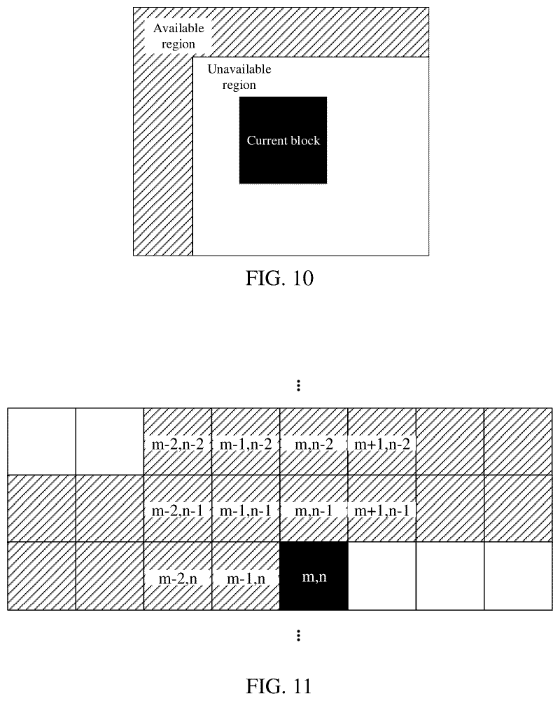

For example, FIG. 10 is a schematic structural diagram showing whether an offset location does not overlap a current block according to an embodiment of this application. As shown in FIG. 10, a black filled block represents the current block, a region filled with oblique lines represents an available region, and an unfilled region represents an unavailable region. For the current block, if the offset location indicated by the target block vector parameter is within the unavailable region, the offset location may overlap the current block.

For example, FIG. 11 is a schematic structural diagram showing whether an offset location exceeds an IBC available region according to an embodiment of this application. As shown in FIG. 11, a black filled block represents the current block, a region filled with oblique lines represents an available region, and a reference block within the available region has been reconstructed. In embodiments of this application, in consideration of a storage capability of the buffer, generally, these reference blocks neighboring to the current block (m, n) may serve as available regions for the IBC mode, which are specifically: a reference block (m−2, n−2), a reference block (m−1, n−2), a reference block (m, n−2), a reference block (m+1, n−2), a reference block (m−2, n−1), a reference block (m−1, n−1), a reference block (m, n−1), a reference block (m+1, n−1), a reference block (m−2, n), a reference block (m−1, n), and the like.

It should also be understood that in this embodiment of this application, after scaling is performed on the first block vector parameter of the first color component block based on the color sampling format, it is necessary to modify the obtained initial block vector parameter. Before the modification is performed, the method may further include: determining whether the initial block vector parameter meets an available condition; and when the initial block vector parameter meets the available condition, modifying the initial block vector parameter of the current block to determine the target block vector parameter of the current block; or when the initial block vector parameter does not meet the available condition, adjusting the initial block vector parameter of the current block until the adjusted block vector parameter meets the available condition; and modifying the adjusted block vector parameter to determine the target block vector parameter of the current block.

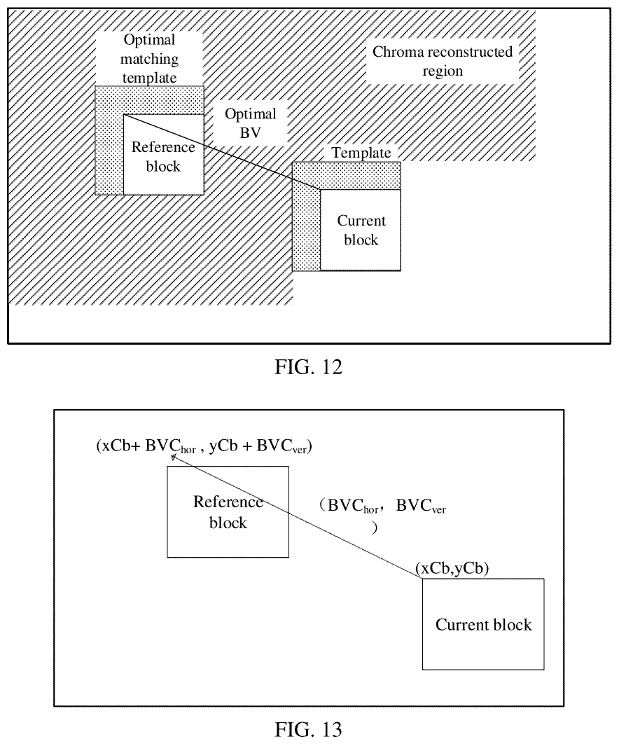

For example, after chroma BV parameters scaled based on the chroma sampling format are obtained and if the chroma BV parameters meet the available condition, the chroma BV parameters are modified using an IntraTMP mode. Specifically, after the modified chroma BV parameters are obtained, an offset location is found based on a location of the current block and the modified chroma BV parameters. Then, a fine search is performed near the offset location using the template matching manner, to obtain optimal chroma BV parameters. A reference block at an optimal offset location obtained after the fine search is copied, to obtain a chroma predicted block for the current block. As shown in FIG. 12, a region filled with oblique lines represents a chroma reconstructed region. For the current block, an optimal matching template and a corresponding optimal BV may be found using a template matching manner, and a reference block for the current block may be determined based on the optimal BV (that is, IntraTMP BV), so as to determine a chroma predicted value for the current block.

It may also be understood that in embodiments of this application, at least one candidate block at a preset location is determined from the plurality of blocks obtained by partitioning the first color component region. The at least one candidate block is acquired according to a preset order and subjected to mode determination; and if it is determined that the IBC mode is used for the first candidate block, the first candidate block is used as the first color component block of the current block. In this process, it is further necessary to determine whether BV parameters of the first candidate block meet the available condition, to determine whether it is necessary to perform mode determination on a next candidate block.

In some embodiments, the method may further include: in a case that it is determined that the IBC mode is used for the first candidate block, determining a first block vector parameter of the first candidate block; determining whether the first block vector parameter of the first candidate block meets an available condition; and in a case that the first block vector parameter of the first candidate block meets the available condition, using the first candidate block as the first color component block of the current block; or in a case that the first block vector parameter of the first candidate block does not meet the available condition, performing mode determination on a next candidate block, until a target candidate block for which the IBC mode is used and whose first block vector parameter meets the available condition is determined, wherein the target candidate block is used as the first color component block of the current block.

Further, in some embodiments, the method may further include: in a case that there is no target candidate block for which the IBC mode is used and whose first block vector parameter meets the available condition among the at least one candidate block, performing intra prediction on the second color component of the current block using a first preset mode, to determine the predicted value for the second color component of the current block, where the first preset mode includes at least one of: a planar mode, a DM mode, a DC mode, a CCLM mode, or a skip mode.

In embodiments of this application, FIG. 9 is still used as an example, in which there are CUs at five luma pixel locations (including, but are not limited to five locations, and may be a plurality of different locations), and the order in which the CUs are acquired includes, but is not limited to the following order:

$$C -> TL -> TR -> BL -> BR .$$

First, it is determined whether there is a CU for which the IBC mode is used among the acquired CUs at the five locations. If a determination result is negative, no luma CU is acquired, and chroma prediction is performed on the current block using the first preset mode. The first preset mode includes, but is not limited to, the planar mode, the inter-component prediction mode (such as the CCLM mode), or other angular prediction modes, or the mode may be skipped, that is, both the encoding side and the decoding side perform determination.

If there is one or more CUs for which the IBC mode is used among the CUs at the five locations, CUs at the five locations may be sequentially acquired again (until a first CU that meets the following conditions is found). In this case, not only whether the IBC mode is used for the CU is determined, but also luma BV parameters of the CU are adjusted, to determine BV parameters to be applied to the chroma. Then, whether the chroma BV parameters are available is determined.

If the chroma BV parameters are available, the CU is selected as a final luma block for BV acquisition.

If the chroma BV parameters are unavailable, no luma CU is acquired, where the first preset mode including but not limited to the planar mode, the inter-component prediction mode, or other angular prediction modes is performed, or even this mode may be skipped. Alternatively, a first CU for which the IBC mode is used is found, BVs of the first CU are adjusted until the CU is available, and the CU is selected as a final luma block for BV acquisition.

Further, in some embodiments, the process of performing IBC extension mode-based prediction on the second color component of the current block by using the target block vector parameter, to determine a predicted value for the second color component of the current block may include: determining an offset location of the current block based on the target block vector parameter and location information of the current block; performing block copying based on the offset location of the current block, to obtain a first predicted block; and determining the predicted value for the second color component of the current block based on the first predicted block.

In embodiments of this application, if IBC extension mode-based prediction is performed on the second color component of the current block, the location information (xCb, yCb) of the current block may be acquired, and chroma BV parameters (BVCₕₒᵣ, BVCᵥₑᵣ) may be acquired. In this way, the offset location (xCb+BVCₕₒᵣ, yCb+BVCᵥₑᵣ) may be found for block copying, as shown in FIG. 13.

For example, cbWidth represents a width of the current block in the chroma sample, cbHeight represents a height of the current block in the chroma sample, and predSamples[x][y] represents a chroma predicted value for the current block. A specific process is as follows:

$$For x = xCb … xCb + cbWidth - 1 and y = yCb … yCb + cbHeight - 1 ;$$

$$xVb = ( xCb + BVChor ) \& ( IbcBufWidthC - 1 ) ;$$

$$yVb = ( yCb + BVCver ) \& ( CtbSizeC - 1 ) ;$$

$$predSamples [ x ] [ y ] = ibcVirChromaBuf [ xVb ] [ yVb ] .$$

IbcBufWidthC represents a width of chroma pixels of a reconstruction buffer stored for IBC, CtbSizeC represents a size of chroma pixels of a CTU, and ibcVirChromaBuf represents reconstructed chroma pixels stored for IBC.

Further, in some embodiments, the process of determining the predicted value for the second color component of the current block based on the first predicted block may include: performing modification on the first predicted block to determine the predicted value for the second color component of the current block.

In a specific embodiment, the process of determining the predicted value for the second color component of the current block based on the first predicted block may include: performing intra prediction on the second color component of the current block using a second preset mode, to obtain a second predicted block; and performing weighted fusion on the first predicted block and the second predicted block to determine the predicted value for the second color component of the current block, where the second preset mode includes at least one of: a planar mode, a DM mode, a DC mode, or a CCLM mode.

It should be understood that in embodiments of this application, if the predicted value for the second color component of the current block is obtained by block copying based on the target block vector parameter, the predicted value may be modified in a manner such as performing weighting based on a conventional prediction mode.

It should also be understood that in embodiments of this application, the modification of the predicted value for the second color component of the current block may include: limiting the predicted value to be within a preset value range, such as between 0 and (1<<BitDepth)−1, where BitDepth represents a bit depth required for the chroma component. The modification may even be filtering or enhancement processing, to improve chroma prediction quality in this mode. No specific limitations are imposed on a type of the modification.

For example, determining the chroma predicted value for the current block is used as an example. If the chroma predicted value is obtained by block copying based on BVs, the chroma predicted value may be modified using a manner such as performing weighting based on a conventional chroma prediction mode. If the chroma predicted value is obtained using the planar mode, the inter-component prediction mode, or other angular prediction modes, the chroma prediction value may be modified using a manner such as performing weighting based on a conventional chroma prediction mode.

According to the method for determining a prediction mode provided in this embodiment, in a process of determining a chroma prediction mode based on a luma prediction mode, if the prediction mode of the luma block corresponding to the current block is the IBC mode, the target block vector parameter to be applied to the chroma component can be determined based on the block vector parameter of the luma block, and the IBC extension mode-based prediction is performed on the chroma component by using the target block vector parameter, to determine the chroma predicted value for the current block, so that a problem of monotony in chroma prediction is resolved, the IBC mode is implicitly applied to chroma prediction, and related information of the co-located luma block is fully utilized, thereby improving accuracy of chroma prediction, reducing a code rate, improving coding efficiency, and thus improving coding performance.

In another embodiment of this application, based on the method for determining a prediction mode described in the above embodiment, a new prediction mode INTRA_DBV is introduced here. Assuming that the first color component is a luma component and the second color component is a chroma component, performing chroma prediction using the INTRA_DBV mode is used as an example for detailed description below.

For the INTRA_DBV mode, a prediction process may include: obtaining a corresponding luma block CU, determining whether a prediction mode of the corresponding luma block CU is an IBC mode (if it is the IBC mode, BV parameters of the corresponding luma block are obtained; if it is not the IBC mode, chroma encoding is performed using a first preset mode, such as the planar mode, or another chroma prediction mode, or this mode is skipped); if the prediction mode is the IBC mode, adjusting the BV parameters to apply to chroma, and determining whether the adjusted BV parameters are available (if they are available, chroma IBC prediction is performed, or if they are unavailable, the BV parameters are adjusted until they are available, and chroma IBC prediction continues to be performed; in the case of the BV parameters being unavailable, the planar mode or another chroma prediction mode may be used or the mode may be skipped, and then corresponding chroma prediction is performed or the processing is skipped).

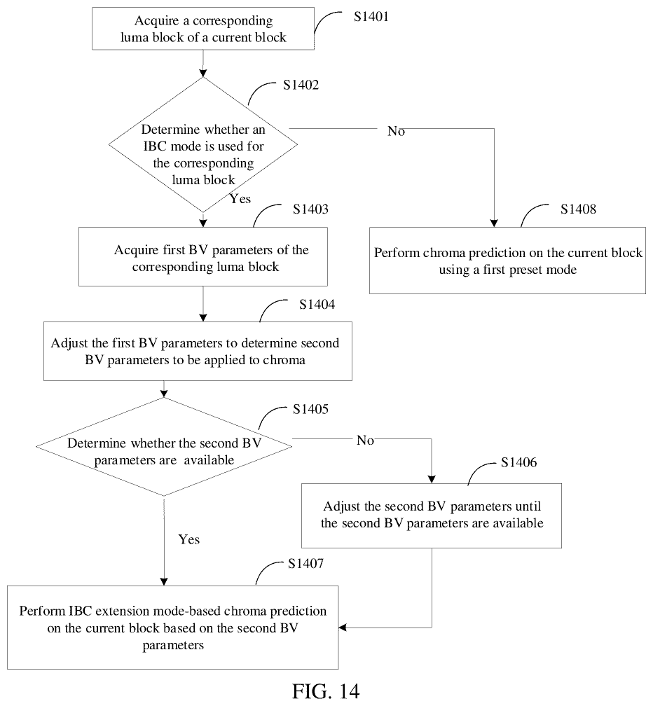

FIG. 14 is a detailed schematic flowchart of a method for determining a prediction mode according to an embodiment of this application. As shown in FIG. 14, the detailed process may include S1401 to S1408.

In S1401, a luma block of a current block is acquired.

In S1402, whether an IBC mode is used for the luma block is determined.

In S1403, first BV parameters of the luma block are obtained.

In S1404, the first BV parameters are adjusted to determine second BV parameters to be applied to chroma.

In S1405, whether the second BV parameters are available is determined.

In S1406, the second BV parameters are adjusted until the second BV parameters are available.

In S1407, IBC extension mode-based chroma prediction is performed on the current block by using the second BV parameters.

In S1408, chroma prediction is performed on the current block using a first preset mode.

It should be noted that in embodiments of this application, the luma block is used to indicate a co-located luma CU for the chroma component of the current block. For S1402, if a determining result is positive, S1403 to S1407 may be performed. If a determining result is negative, S1408 may be performed. For S1405, if a determining result is positive, S1407 may be performed. If a determining result is negative, S1407 may be performed after S1406 is performed.

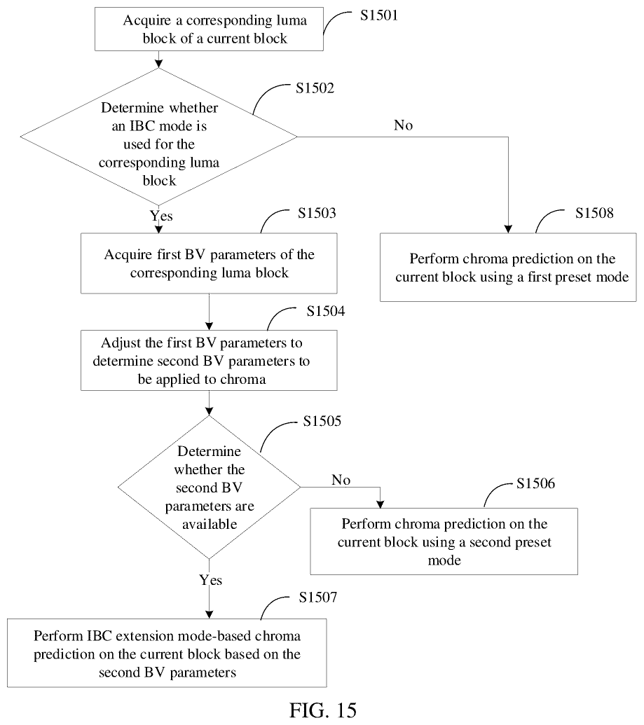

In another specific embodiment, FIG. 15 is a detailed schematic flowchart of another method for determining a prediction mode according to an embodiment of this application. As shown in FIG. 15, the detailed process may include S1501 to S1508.

In S1501, a luma block of a current block is acquired.

In S1502, whether an IBC mode is used for the luma block is determined.

In S1503, first BV parameters of the luma block are obtained.

In S1504, the first BV parameters are adjusted to determine second BV parameters to be applied to chroma.

In S1505, whether the second BV parameters are available is determined.

In S1506, chroma prediction is performed on the current block using a second preset mode.

In S1507, IBC extension mode-based chroma prediction is performed on the current block by using the second BV parameters.

In S1508, chroma prediction is performed on the current block using a first preset mode.

It should be noted that in embodiments of this application, the luma block is used to indicate a co-located luma CU for the chroma component of the current block. For S1502, if a determining result is positive, S1503 to S1507 may be performed. If a determining result is negative, S1508 may be performed. For S1505, if a determining result is positive, S1507 may be performed. If a determining result is negative, S1506 may be performed first.

It should also be noted that in embodiments of this application, the first preset mode may be the same as or different from the second preset mode. For example, the first preset mode may be the planar mode or another chroma prediction mode, or this mode may be skipped; and the second preset mode may be the planar mode or another chroma prediction mode, or this mode may be skipped, which is not specifically limited.

It may be understood that, based on the detailed process shown in FIG. 14 or FIG. 15, a specific process is as follows.

For the acquired luma block, the luma CU acquired here may be at any location, including but not limited to the following locations: a CU at a center location in the co-located luma region as shown in FIG. 3, a CU at a top-left corner in the co-located luma region as shown in FIG. 7, a CU at a bottom-right corner in the co-located luma region as shown in FIG. 8, a CU at a preset location in the co-located luma region as shown in FIG. 9, and the like. The locations are not specifically limited here.

The process of determining whether the IBC mode is used for the luma block includes determining whether the prediction mode of the luma block is the IBC mode. After the CU at the corresponding location is acquired, whether the prediction mode of the CU is the IBC mode is determined. If the prediction mode is the IBC mode, first BV parameters of the luma block are acquired. If the prediction mode is not the IBC mode, the chroma component is encoded using the first preset mode, including but not limited to the planar mode, or the CCLM mode, or other angular prediction modes, and it is necessary to acquire reference pixels and parameters for chroma prediction, or this mode may be skipped, that is, both the encoding side and the decoding side perform determination.

The first BV parameters are adjusted to be applied to chroma. After the first BV parameters of the luma block are acquired, the first BV parameters are adjusted to obtain second BV parameters to be applied to chroma. Assuming that the first BV parameters are (BVLₕₒᵣ, BVLᵥₑᵣ) and the second BV parameters are (BVCₕₒᵣ, BVCᵥₑᵣ), adjustment manners include but not limited to the following manners.

In Manner 1, as shown in Table 7, the first BV parameters are scaled based on the color sampling format, to obtain the second BV parameters to be applied to chroma.

In Manner 2, the second BV parameters are modified. After the second BV parameters scaled based on the color sampling format are obtained, the second BV parameters may be directly used, or may be modified. Before the modification, it is necessary to determine whether the second BV parameters are available. If the second BV parameters are available, the second BV parameters are modified; or if the second BV parameters are unavailable, the second BV parameters are adjusted until the second BV parameters are available, and then the adjusted second BV parameters are modified. The modification here includes but not limited to performing modification using an IntraTMP mode. That is, after the second BV parameters are obtained, an offset location is found based on a location of the current block and the second BV parameters. Then, a fine search is performed near the offset location using a template matching manner, to obtain optimal BV parameters. A reference block at an optimal offset location obtained after the fine search is copied, to obtain a chroma predicted block for the current block, as shown in FIG. 12.

For determining whether the second BV parameters are available, the location (xCb, yCb) of the current block is acquired, the second BV parameters acquired are (BVCₕₒᵣ, BVCᵥₑᵣ), the offset location (xCb+BVCₕₒᵣ, yCb+BVCᵥₑᵣ) is found. If all the following conditions are met, it is determined that the second BV parameters are available:
whether the obtained offset location does not exceed an image boundary;
whether the obtained offset location does not overlap the current block;
whether the obtained offset location does not exceed an IBC available region; and
whether the obtained offset location has been reconstructed.

Here, if the second BV parameters are available, chroma prediction is performed using the IBC mode. If the second BV parameters are unavailable, it is necessary to adjust the second BV parameters to be available and then chroma prediction is performed using the IBC mode. Adjustment manners include but are not limited to cropping, scaling, and the like. In addition, if the second BV parameters are unavailable, modes including but not limited to the planar mode or the CCLM mode or other angular prediction modes may be used, and reference pixels and mode parameters may be acquired for chroma prediction, or this mode may even be skipped.

For chroma IBC prediction, IBC extension mode-based chroma prediction is performed on the current block by using the second BV parameters. If the prediction mode is the IBC extension mode, the location (xCb, yCb) of the current block is acquired, the second BV parameters acquired are (BVCₕₒᵣ, BVCᵥₑᵣ), the offset location (xCb+BVCₕₒᵣ, yCb+BVCᵥₑᵣ) is found, and block copying is performed, as shown in FIG. 13.

In addition, if the second BV parameters are unavailable and a mode such as the planar mode or the CCLM mode or other angular modes is used, reference pixels and mode parameters are acquired for chroma prediction.

It may also be understood that for the method for determining a prediction mode in the above embodiments, in this embodiment of this application, the DM mode in the related technology may be modified, such that the modified DM mode can be compatible with the INTRA_DBV mode.

In embodiments of this application, under dual-tree partitioning and the DM mode, when the prediction mode of the co-located luma block is the IBC mode, and if CuPredMode[0][xCb+cbWidth/2][yCb+cbHeight/2] is equal to MODE_IBC, lumaIbcPredMode is Y, Y is different from X, and Y does not represent a conventional angular prediction mode, the chroma intra prediction mode IntraPredModeC[xCb][yCb] is INTRA_DBV.

The chroma prediction mode is derived as follows.

The chroma intra prediction mode IntraPredModeC[xCb][yCb] is derived using cclm_mode_flag, cclm_mode_idx, and intra_chroma_pred_mode, lumaIntraPredMode, and lumaIbcPredMode as specified in Table 8.

TABLE 8

| | | | | lumaIntraPredMode | | | | |
|---|---|---|---|---|---|---|---|---|
| | | | lumaIbcPredMode | | | | | X |
| cclm_mode_flag | cclm_mode_idx | intra_chroma_pred_mode | Y | 0 | 50 | 18 | 1 | (0 <= X <= 66) |
| 0 | — | 0 | 0 | 66 | 0 | 0 | 0 | 0 |
| 0 | — | 1 | 50 | 50 | 66 | 50 | 50 | 50 |
| 0 | — | 2 | 18 | 18 | 18 | 66 | 18 | 18 |
| 0 | — | 3 | 1 | 1 | 1 | 1 | 66 | 1 |
| 0 | — | 4 | INTRA_DBV | 0 | 50 | 18 | 1 | X |
| 1 | 0 | — | 81 | 81 | 81 | 81 | 81 | 81 |
| 1 | 1 | — | 82 | 82 | 82 | 82 | 82 | 82 |

In this embodiment of this application, prediction is performed using the INTRA_DBV mode, and a specific process may be the same as the process shown in FIG. 14 or FIG. 15 in the above embodiments. If the prediction mode of the acquired CU at the center location in the co-located luma region is not the IBC mode, a corresponding luma prediction mode of the CU may be acquired to perform chroma prediction.

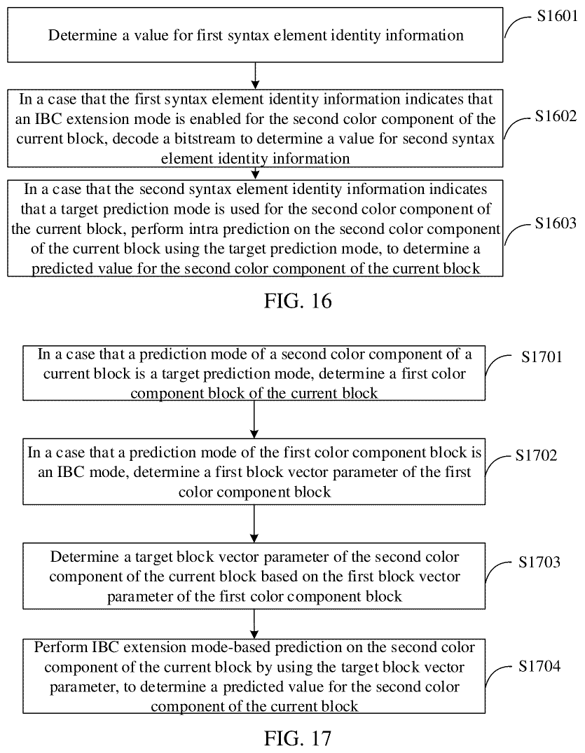

Specific implementation of the previous embodiment is explained in detail through the above embodiment, and it may be seen that a new chroma prediction mode INTRA_DBV is proposed here. For the DM mode, in the case of dual-tree partitioning, if the prediction mode of the CU at the luma center location is the IBC mode, the acquired chroma prediction mode is the DC mode. According to this embodiment of this application, the manner of acquiring the fixed prediction mode is effectively improved, the mode information of the co-located luma region is fully utilized, and the fixed prediction mode is replaced with flexible BV parameters, thereby effectively improving the accuracy of chroma prediction. In addition, for the new prediction mode, in the case of dual-tree partitioning, if the prediction mode of the luma block is the IBC mode, BV parameters of the luma block are obtained, and the BV parameters are adjusted to be applied to the chroma, thereby resolving the monotony problem in chroma prediction. The IBC algorithm is implicitly applied into chroma prediction, and information of the co-located luma region is fully utilized, thereby improving the accuracy of chroma prediction, and thus effectively improving coding efficiency. It should be noted that, the method for determining a prediction mode provided in embodiments of this application may be extended to be applied to a plurality of prediction modes based on BV information. For example, a method for determining a prediction mode shown in FIG. 16 may be applied to a scenario in which a first color component block is predicted based on a prediction mode including BV information (for example IBC mode or IntraTMP mode); and the methods for determining a prediction mode shown in FIG. 14 and FIG. 15 may be applied to a scenario in which a corresponding luma block of a current block is predicted based on a prediction mode including BV information (for example IBC mode or IntraTMP mode).

In another embodiment of this application, reference is made to FIG. 16, which is a schematic flowchart of a decoding method according to an embodiment of this application. As shown in FIG. 16, the method may include S1601 to S1603.

In S1601, a value for first syntax element identity information is determined.

It should be noted that the method in this embodiment of this application may be applied to a decoder. In addition, the decoding method here may specifically refer to an intra prediction method. Assuming that a first color component is a luma component and a second color component is a chroma component. More specifically, the method here is a chroma intra prediction method. In this method, chroma prediction may be performed using the IBC extension mode proposed in the above embodiment, so that the accuracy of chroma prediction can be improved.

It should also be noted that, in embodiments of this application, the current block includes at least a first color component and a second color component. For the first color component of the current block, the block in this case may be referred to as a first color component block. When the first color component is a luma component, the first color component block may also be referred to as a luma block. Similarly, for the second color component of the current block, the block in this case may be referred to as a second color component block. When the second color component is a chroma component, the second color component block may also be referred to as a chroma block.

It should also be noted that in this embodiment of this application, the first syntax element identity information may be represented by IbcEnabled or may be represented by chromaIbcExModeEnabled. The value of the first syntax element identity information determines whether related mode parameters are transmitted at the CU layer. The first syntax element identity information is used to indicate whether the IBC extension mode is enabled for the second color component of the current block. In other words, the first syntax element identity information may be used to indicate whether a target prediction mode (i.e., INTRA_DBV mode) is enabled for the second color component of the current block. In some embodiments, the method may further include:
in a case that the value for the first syntax element identity information is a first value, determining that the first syntax element identity information indicates that an IBC extension mode is enabled for the second color component of the current block; and
in a case that the value for the first syntax element identity information is a second value, determining that the first syntax element identity information indicates that an IBC extension mode is disabled for the second color component of the current block.

In embodiments of this application, the first value is different from the second value, and the first value and the second value may be in a parametric form or numeric form. Specifically, the first syntax element identity information may be a parameter described in the profile or a value of a flag, which is not specifically limited here.

For example, for the first value and the second value, the first value may be set to 1 and the second value may be set to 0. Alternatively, the first value may be set to 0, and the second value may be set to 1. Alternatively, the first value may be set to true, and the second value may be set to false. Alternatively, the first value may be set to false, and the second value may be set to true. In this embodiment of this application, the first value is set to 1, and the second value is set to 0, but the first value and the second value are not specifically limited.

In this embodiment of this application, the process of determining the value for the first syntax element identity information may include: decoding a bitstream to determine the value for the first syntax element identity information. Alternatively, the process of determining the value for the first syntax element identity information may include: decoding a bitstream to determine a value for third syntax element identity information; and if the value for the third syntax element identity information is a first value and the current block meets a preset condition, determining that the value for the first syntax element identity information is the first value; or if the value for the third syntax element identity information is a second value, determining that the value for the first syntax element identity information is the second value.

In a specific embodiment, the current block meeting the preset condition may include at least: a slice type of the current block is an I-frame; and a size of the current block meets a requirement of a preset upper limit.

It should be understood that in this embodiment of this application, the slice type of the current block may be represented by sh_slice_type, the preset upper limit may be represented by MaxChromaIbcSize, and MaxChromaIbcSize may be determined based on a size of a chroma CTU or a preset value.

It should also be understood that in this embodiment of this application, the third syntax element identity information may be represented by sps_ibc_enabled_flag, to indicate whether the IBC mode is enabled for the current image. Here, the current image includes the current block. In some embodiments, the method may further include:
in a case that the value for the third syntax element identity information is the first value, determining that the third syntax element identity information indicates that an IBC mode is enabled for a current image; and
in a case that the value for the third syntax element identity information is the second value, determining that the third syntax element identity information indicates that an IBC mode is disabled for a current image.

In embodiments of this application, the first value is different from the second value, and the first value and the second value may be in a parametric form or numeric form. Specifically, the third syntax element identity information may be a parameter described in the profile or a value of a flag, which is not specifically limited here.

For example, setting the first value to 1 and the second value to 0 is used as an example. If the value of sps_ibc_enabled_flag is equal to 0, the value of IbcEnabled is equal to 0. If the value of sps_ibc_enabled_flag is equal to 1 and if the following conditions are all met (including but not limited to the following conditions), the value of IbcEnabled is equal to 1. These conditions may include but are not limited to: sh_slice_type is an I-frame; and CtbLog2SizeY is less than or equal to MaxChromaIbcSize.

It should also be noted that in embodiments of this application, the value for the first syntax element identity information may be determined based on the third syntax element identity information and whether the current block meets the preset condition; or may be directly determined by decoding the bitstream, which is not specifically limited here. For example, in this embodiment of this application, the first syntax element identity information may serve as a syntax element that is not transmitted in the bitstream, and may be a value derived based on values of sps_ibc_enabled_flag, sh_slice_type, and CtbLog2SizeY.

In this way, when the value of IbcEnabled is equal to 1, it may be determined that the first syntax element identity information indicates that the IBC extension mode is enabled for the second color component of the current block.

In S1602, in a case that the first syntax element identity information indicates that an IBC extension mode is enabled for a second color component of a current block, a bitstream is decoded to determine a value for second syntax element identity information.

In embodiments of this application, if the IBC extension mode is enabled for the second color component of the current block, that is, a target prediction mode is enabled for the second color component of the current block, it is necessary to further determine whether the target prediction mode is used for the second color component of the current block, that is, the value for the second syntax element identity information is determined by decoding. In some embodiments, the method may further include:
in a case that the value for the second syntax element identity information is a first value, determining that the second syntax element identity information indicates that the target prediction mode is used for the second color component of the current block; and
in a case that the value for the second syntax element identity information is a second value, determining that the second syntax element identity information indicates that the target prediction mode is not used for the second color component of the current block.

In this embodiment of this application, the second syntax element identity information may be represented by intra_dbv_flag or intra_chroma_ibc_flag, to indicate whether the target prediction mode is used for the second color component of the current block.

In embodiments of this application, the first value is different from the second value, and the first value and the second value may be in a parametric form or numeric form. Specifically, the second syntax element identity information may be a parameter described in the profile or a value of a flag, which is not specifically limited here.

For example, setting the first value to 1 and the second value to 0 is used as an example. If the value for the first syntax element identity information is 1, that is, the IBC extension mode is enabled for the second color component of the current block, the value for the second syntax element identity information is determined by decoding. If the value for the second syntax element identity information is also 1, it may be determined that the target prediction mode is used for the second color component of the current block.

In S1603, in a case that the second syntax element identity information indicates that the target prediction mode is used for the second color component of the current block, intra prediction is performed on the second color component of the current block using the target prediction mode, to determine a predicted value for the second color component of the current block.

It should be understood that according to the method for determining a prediction mode in the above embodiments, the determined prediction mode is the target prediction mode. Here, the target prediction mode may be represented by INTRA_DBV.

Further, in some embodiments, the process of performing intra prediction on the second color component of the current block using the target prediction mode, to determine the predicted value for the second color component of the current block may include:
determining a first color component block of a current block; determining a first block vector parameter of the first color component block in a case that a prediction mode of the first color component block is an IBC mode; determining a target block vector parameter of the second color component of the current block based on the first block vector parameter of the first color component block; and performing IBC extension mode-based prediction on the second color component of the current block by using the target block vector parameter, to determine a predicted value for the second color component of the current block.

Further, in some embodiments, the process of performing intra prediction on the second color component of the current block using the target prediction mode, to determine the predicted value for the second color component of the current block may include:
decoding a bitstream to determine a target block vector parameter of the current block; and performing IBC extension mode-based prediction on the second color component of the current block by using the target block vector parameter, to determine a predicted value for the second color component of the current block.

It should also be understood that in this embodiment of this application, if it is determined that the IBC extension mode-based prediction is performed on the chroma component of the current block, first BV parameters of the luma block may be determined when the prediction mode of the luma block is the IBC mode; and the first BV parameters may be adjusted to determine target BV parameters to be applied to the chroma component. Then, IBC extension mode-based chroma prediction may be performed on the current block by using the target BV parameters, to determine the chroma predicted value for the current block. Alternatively, the encoding side may write the target BV parameters into a bitstream after determining the target BV parameters to be applied to the chroma component. Therefore, on the decoding side, the target BV parameters of the current block may be directly obtained through decoding, and then the IBC extension mode-based chroma prediction is performed on the current block by using the target BV parameters, to determine the chroma predicted value for the current block.

Further, in some embodiments, the method may further include: in a case that the value for the second syntax element identity information is the second value, decoding a bitstream to determine a value for fourth syntax element identity information; determining a first intra prediction mode of the second color component of the current block based on the value for the fourth syntax element identity information; and performing intra prediction on the second color component of the current block using the first intra prediction mode, to determine the predicted value for the second color component of the current block.

In embodiments of this application, the fourth syntax element identify information may be represented by intra_chroma_pred_mode, to indicate a chroma intra prediction mode used for the current block.

For example, in a case in which intra_dbv_flag or intra_chroma_ibc_flag is equal to 0, the target prediction mode is no longer used, but chroma prediction is performed on the current block using the chroma intra prediction mode indicated by intra_chroma_pred_mode, to determine the chroma predicted value for the current block.

In a specific embodiment, the chroma prediction mode INTRA_DBV provided in embodiments of this application, in decoding implementation, may be, for example, added at the following decoding location:

(1) The chroma prediction mode INTRA_DBV may be added before intra_chroma_pred_mode, as shown in Table 9.

TABLE 9

| | |
|---|---|
| if( !cu_act_enabled_flag ) { | |
| if( cbWidth/SubWidthC <= MaxTsSize && | |
| cbHeight/SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| if( IbcEnabled ){ | |
| intra_dbv_flag | ae(v) |
| if( !intra_dbv_flag) | |
| intra_chroma_pred_mode | ae(v) |
| } | |
| else | |
| intra_chroma_pred_mode | ae(v) |
| } | |
| } | |

If sps_ibc_enable_flag is equal to 0, IbcEnabled is equal to 0.

Otherwise, IbcEnabled is equal to 1 if the following conditions are all met (including but not limited to the following conditions):
sh_slice_type is an I-frame; and
CtbLog2SizeY is less than or equal to MaxChromaIbcSize.

MaxChromaIbcSize may be determined based on a chroma CTU size or a preset value.

In addition, if intra_dbv_flag is TRUE, it indicates that the current chroma prediction mode is INTRA_DBV, including but not limited to the following binarization manner, and encoding may be performed using a context model or a bypass model, for example, as shown in Table 10, Table 11, Table 12, or Table 13. Here, FL indicates a fixed length.

TABLE 10

| | | |
|---|---|---|
| intra_dbv_flag | FL | cMax=1 |

TABLE 11

| Value of intra_chroma_pred_mode | Bin string |
|---|---|
| 0 | 100 |
| 1 | 101 |
| 2 | 110 |
| 3 | 111 |
| 4 | 0 |

TABLE 12

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_dbv_flag | 0 | na | na | na | na | na |
| intra_chroma_pred_mode | 0 | bypass | bypass | na | na | na |

TABLE 13

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_dbv_flag | bypass | na | na | na | na | na |
| intra_chroma_pred_mode | 0 | bypass | bypass | na | na | na |

(2) The chroma prediction mode INTRA_DBV may be added before intra_chroma_pred_mode in another implementation, specifically as shown in Table 14.

TABLE 14

| | |
|---|---|
| if( !cu_act_enabled_flag ) { | |
| if( cbWidth/SubWidthC <= MaxTsSize && | |
| cbHeight/SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| if( IbcEnabled ) | |
| intra_chroma_ibc_flag | ae(v) |
| if(!intra_chroma_ibc_flag) | |
| intra_chroma_pred_mode | ae(v) |
| } | |
| } | |

If sps_ibc_enabled_flag is equal to 0, IbcEnabled is equal to 0.

Otherwise, IbcEnabled is equal to 1 if the following conditions are all met (including but not limited to the following conditions):
sh_slice_type is an I-frame; and
CtbLog2SizeY is less than or equal to MaxChromaIbcSize.

MaxChromaIbcSize may be determined based on a chroma CTU size or a preset value.

If IbcEnabled is equal 0, intra_chroma_ibc_flag is inferred as FALSE.

If intra_chroma_ibc_flag is TRUE, it indicates that the current chroma prediction mode is INTRA_DBV, including but not limited to the following binarization manner, and encoding may be performed using a context model or a bypass model, for example, as shown in Table 15, Table 16, Table 17, or Table 18.

TABLE 15

| | | |
|---|---|---|
| intra_chroma_ibc_flag | FL | cMax=1 |

TABLE 16

| Value of intra_chroma_pred_mode | Bin string |
|---|---|
| 0 | 100 |
| 1 | 101 |
| 2 | 110 |
| 3 | 111 |
| 4 | 0 |

TABLE 17

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_ibc_flag | 0 | na | na | na | na | na |
| Intra_chroma_pred_mode | 0 | bypass | bypass | na | na | na |

TABLE 18

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_ibc_flag | bypass | na | na | na | na | na |
| intra_chroma_pred_mode | 0 | bypass | bypass | na | na | na |

Further, for adding a syntax element, in some embodiments, the method may further include: in a case that the first syntax element identity information indicates that the IBC extension mode is enabled for the second color component of the current block, decoding a bitstream to determine a value for fifth syntax element identity information; determining a second intra prediction mode of the second color component of the current block based on the value for the fifth syntax element identity information; and performing intra prediction on the second color component of the current block using the second intra prediction mode, to determine the predicted value for the second color component of the current block;
or
in a case that the first syntax element identity information indicates that the IBC extension mode is disabled for the second color component of the current block, decoding a bitstream to determine a value for sixth syntax element identity information; and determining a third intra prediction mode of the second color component of the current block based on the value for the sixth syntax element identity information; and performing intra prediction on the second color component of the current block using the third intra prediction mode, to determine the predicted value for the second color component of the current block.

In which, the second intra prediction mode includes the target prediction mode, and the third intra prediction mode does not include the target prediction mode.

In embodiments of this application, the fifth syntax element identity information may be represented by chroma_pred_mode_add, and the sixth syntax element identity information may be represented by intra_chroma_pred_mode, where intra_chroma_pred_mode_add is used to indicate that the INTRA_DBV mode is added and intra_chroma_pred_mode represents a chroma prediction mode in the related technology.

In embodiments of this application, a binarization process of the fifth syntax element identity information is different from a binarization process of the sixth syntax element identity information, that is, the binary mapping tables used for the fifth and sixth syntax element identity information are different.

In some embodiments, the process of decoding a bitstream to determine a value for fifth syntax element identity information includes: decoding the bitstream to obtain at least one character corresponding to the fifth syntax element identity information; and mapping, using a first preset binary mapping table, the at least one character corresponding to the fifth syntax element identity information, to determine the value for the fifth syntax element identity information.

In some embodiments, the process of decoding a bitstream to determine a value for sixth syntax element identity information includes: decoding the bitstream to obtain at least one character corresponding to the sixth syntax element identity information; and mapping, using a second preset binary mapping table, the at least one character corresponding to the sixth syntax element identity information, to determine the value for the sixth syntax element identity information.

For example, in a case in which IbcEnabled is equal to 1, intra_chroma_pred_mode_add is decoded using the first preset binary mapping table, and chroma prediction is performed on the current block using the chroma intra prediction mode indicated by chroma_pred_mode_add, to determine the chroma predicted value for the current block. In a case in which IbcEnabled is equal to 0, intra_chroma_pred_mode is decoded using the second preset binary mapping table, and chroma prediction is performed on the current block using the chroma intra prediction mode indicated by intra_chroma_pred_mode, to determine the chroma predicted value for the current block.

In another specific embodiment, a chroma prediction mode INTRA_DBV provided in embodiments of this application, in decoding implementation, further includes:

(3) The syntax element intra_chroma_pred_mode_add is added, specifically as shown in Table 19.

TABLE 19

| | |
|---|---|
| if( !cu_act_enabled_flag ) { | |
| if( cbWidth/SubWidthC <= MaxTsSize && | |
| cbHeight/SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| if( IbcEnabled ) | |
| intra_chroma_pred_mode_add | ae(v) |
| else | |
| intra_chroma_pred_mode | ae(v) |
| } | |
| } | |

If sps_ibc_enabled_flag is equal to 0, IbcEnabled is equal to 0.

Otherwise, IbcEnabled is equal to 1 if the following conditions are all met (including but not limited to the following conditions):
sh_slice_type is an I-frame; and
CtbLog2SizeY is less than or equal to MaxChromaIbcSize.

MaxChromaIbcSize may be determined based on a chroma CTU size or a preset value.

In addition, a binarization manner of intra_chroma_pred_mode_add, that is, the first preset binary mapping table, may be as shown in Table 20, which is not specifically limited.

TABLE 20

| Value of intra_chroma_pred_mode_add | Bin string |
|---|---|
| 0 | 1100 |
| 1 | 1101 |
| 2 | 1110 |
| 3 | 1111 |
| 4 | 10 |
| 5 | 0 |

In addition, a binarization manner of Value of intra_chroma_pred_mode, that is, the second preset binary mapping table, may be as shown in Table 21, which is not specifically limited.

TABLE 21

| Value of intra_chroma_pred_mode | Bin string |
|---|---|
| 0 | 100 |
| 1 | 101 |
| 2 | 110 |
| 3 | 111 |
| 4 | 0 |

In addition, for different syntax elements (such as cclm_mode_flag, cclm_mode_idx, intra_chroma_pred_mode_add, and intra_chroma_pred_mode), an encoding method used for each encoding bit is specifically as shown in Table 22 or Table 23.

TABLE 22

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode_add | 0 | 0 | bypass | bypass | na | na |
| intra_chroma_pred_mode | 0 | bypass | bypass | na | na | na |

TABLE 23

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode_add | 0 | bypass | bypass | bypass | na | na |
| Intra_chroma_pred_mode | 0 | bypass | bypass | na | na | na |

Here, intra_chroma_pred_mode_add is used as an example. The 0^{th} bit of intra_chroma_pred_mode_add indicates the DM mode, and an encoding method is the same as that in VVC. The 1^{st} bit of intra_chroma_pred_mode_add indicates the newly added INTRA_DBV mode, and encoding may be performed using a context model or a bypass model.

Further, for the case of maintaining the syntax element, in some embodiments, the process of decoding a bitstream to determine a value for second syntax element identity information may include: in a case that the first syntax element identity information indicates that the IBC extension mode is enabled for the second color component of the current block, decoding a bitstream to obtain at least one character corresponding to the second syntax element identity information; and mapping, using a first preset binary mapping table, the at least one character corresponding to the second syntax element identity information, to determine the value for the second syntax element identity information; or
in a case that the first syntax element identity information indicates that the IBC extension mode is disabled for the second color component of the current block, decoding a bitstream to obtain at least one character corresponding to the second syntax element identity information; and mapping, using a second preset binary mapping table, the at least one character corresponding to the second syntax element identity information, to determine the value for the second syntax element identity information.

In embodiments of this application, the second syntax element identity information may be represented by intra_chroma_pred_mode. That is, the syntax element intra_chroma_pred_mode is maintained. In this case, different binarization manners may be used depending on different values of IbcEnabled.

In still another specific embodiment, a chroma prediction mode INTRA_DBV provided in embodiments of this application, in decoding implementation, further includes:

(4) The syntax element intra_chroma_pred_mode is maintained, specifically as shown in Table 24.

TABLE 24

| | |
|---|---|
| if( !cu_act_enabled_flag ) { | |
| if( cbWidth/SubWidthC <= MaxTsSize && | |
| cbHeight/SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

If sps_ibc_enabled_flag is equal to 0, IbcEnabled is equal to 0.

Otherwise, IbcEnabled is equal to 1 if the following conditions are all met (including but not limited to the following conditions):
sh_slice_type is equal to an I-frame; and
CtbLog2SizeY is less than or equal to MaxChromaIbcSize.

MaxChromaIbcSize may be determined based on a chroma CTU size or a preset value.

In addition, intra_chroma_pred_mode includes but is not limited to the following binarization manner:

When IbcEnabled is equal to 1, intra_chroma_pred_mode is binarized using Table 25, but is not limited to this.

TABLE 25

| Value of intra_chroma_pred_mode | Bin string |
|---|---|
| 0 | 1100 |
| 1 | 1101 |
| 2 | 1110 |
| 3 | 1111 |
| 4 | 10 |
| 5 | 0 |

Otherwise, if IbcEnabled is equal to 0, intra_chroma_pred_mode is binarized using a manner shown Table 26, and the binarization manner is not limited herein.

TABLE 26

| Value of intra_chroma_pred_mode | Bin string |
|---|---|
| 0 | 100 |
| 1 | 101 |
| 2 | 110 |
| 3 | 111 |
| 4 | 0 |

In addition, for different syntax elements (such as cclm_mode_flag, cclm_mode_idx, and intra_chroma_pred_mode), an encoding method used for each encoding bit is specifically shown as follows:

When IbcEnabled is equal to 1, an encoding method used for each encoding bit is shown in table 27 or table 28.

TABLE 27

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | 0 | bypass | bypass | na | na |

TABLE 28

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | bypass | na | na |

Here, intra_chroma_pred_mode is used as an example. When IbcEnabled is equal to 1, the 0^{th} bit of intra_chroma_pred_mode indicates the DM mode, and an encoding method is the same as that in VVC. The 1^{st} bit of intra_chroma_pred_mode indicates the newly added INTRA_DBV mode, and encoding may be performed using a context model or a bypass model.

When IbcEnabled is equal to 0, an encoding method used for each encoding bit is shown in table 29.

TABLE 29

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

Further, for the case of modifying the DM mode, in some embodiments, the process of decoding a bitstream to determine a value for second syntax element identity information may include: in a case that the value for the second syntax element identity information equals to a first preset constant value, determining that the second syntax element identity information indicates that the target prediction mode is not used for the second color component of the current block; and after a fourth intra prediction mode of the second color component of the current block is determined, performing intra prediction on the second color component of the current block using the fourth intra prediction mode, to determine the predicted value for the second color component of the current block; or
in a case that the value for the second syntax element identity information equals to a second preset constant value, determining that the second syntax element identity information indicates that the target prediction mode is used for the second color component of the current block, and performing intra prediction on the second color component of the current block using the target prediction mode, to determine the predicted value for the second color component of the current block.

In embodiments of this application, the second syntax element identity information is still represented by intra_chroma_pred_mode. In addition, the first preset constant value may be 0, 1, 2, or 3, and the second preset constant value may be 4, which is not specifically limited.

In still another specific embodiment, a chroma prediction mode INTRA_DBV provided in embodiments of this application, in decoding implementation, further includes:

(5) The DM mode is modified, specifically as shown in Table 30.

TABLE 30

| | |
|---|---|
| if( !cu_act_enabled_flag ) { | |
| if( cbWidth/SubWidthC <= MaxTsSize && | |
| cbHeight/SubHeightC <= MaxTsSize && | |
| sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

In addition, for intra_chroma_pred_mode, a binarization manner includes but is not limited to the following binarization manner, and encoding may be performed using a context model or a bypass model, for example, as shown in Table 31 or Table 32.

TABLE 31

| Value of intra_chroma_pred_mode | Bin string |
|---|---|
| 0 | 100 |
| 1 | 101 |
| 2 | 110 |
| 3 | 111 |
| 4 | 0 |

TABLE 32

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

Here, the 0^{th} bit of intra_chroma_pred_mode indicates the DM mode, and an encoding method is the same as that in VVC.

A derivation process of IbcEnabled is as follows:

If sps_ibc_enabled_flag is equal to 0, IbcEnabled is equal to 0.

Otherwise, IbcEnabled is equal to 1 if the following conditions are all met (including but not limited to the following conditions):
sh_slice_type is equal to an I-frame; and
CtbLog2SizeY is less than or equal to MaxChromaIbcSize.

MaxChromaIbcSize may be determined based on a chroma CTU size or a preset value.

If IbcEnabled is equal to 1 and when intra_chroma_pred_mode is equal to 0, 1, 2, or 3, which indicate four chroma prediction modes, the four chroma prediction modes are maintained unchanged. When intra_chroma_pred_mode is equal to 4, a decoding process shown in Table 30 is implemented.

Otherwise, the chroma prediction process in the H.266/VVC standard is maintained unchanged.

In short, in embodiments of this application, for the DM mode, in the case of dual-tree partitioning, if the mode at the luma center location is the IBC mode, the acquired chroma prediction mode is the DC mode. According to the embodiments of the present application, the manner of acquiring the fixed prediction mode is effectively improved, the mode information of the co-located luma region can be fully utilized, and the fixed prediction mode is replaced with flexible BVs, thereby improving the accuracy of chroma prediction. In addition, for the new prediction mode INTRA_DBV, in the case of dual-tree partitioning, if the prediction mode of the luma block is the IBC mode, BVs of the luma block are obtained, and the BVs are adjusted to be applied to the chroma, thereby solving the monotony problem in chroma prediction. In addition, the IBC algorithm is implicitly applied chroma prediction, and information of the co-located luma region is fully utilized, thereby effectively improving the accuracy of chroma prediction.

According to the decoding method provided in embodiments of the present application, in a process of deriving a chroma prediction mode using a luma prediction mode, in a case in which the IBC mode and dual-tree partitioning are enabled at the SPS layer and if the prediction mode of the luma block is the IBC mode, BV parameters of the luma block are acquired, and the BV parameters are adjusted to be applied to the chroma, thereby solving the monotony problem in chroma prediction. In addition, the IBC algorithm is implicitly applied to chroma prediction, and the information of the co-located luma region is fully utilized, so that the chroma block is predicted effectively and accurately, thereby improving the accuracy of chroma prediction, further improving coding efficiency, and thus improving coding performance.

In another embodiment of this application, reference is to FIG. 17, which is a schematic flowchart of an encoding method according to an embodiment of this application. As shown in FIG. 17, the method may include S1701 to S1704.

In S1701, in a case that a prediction mode of a second color component of a current block is a target prediction mode, a first color component block of the current block is determined.

It should be noted that the method in embodiments of this application may be applied to an encoder. In addition, the encoding method here may specifically refer to an intra prediction method. Assuming that a first color component is a luma component and a second color component is a chroma component. More specifically, the method here is a chroma intra prediction method. In this method, chroma prediction may be performed using the IBC extension mode proposed in the above embodiment, so that the accuracy of chroma prediction can be improved.

It should also be noted that in this embodiment of this application, according to the method for determining a prediction mode in the above embodiments, the determined prediction mode is the target prediction mode. Here, the target prediction mode is the IBC extension mode proposed in the above embodiments, and may be represented by INTRA_DBV.

In some embodiments, the process of determining a first color component block of the current block may include: determining a first color component region co-located with the current block; and determining the first color component block of the current block from a plurality of blocks obtained by partitioning the first color component region.

Further, in some embodiments, the process of determining the first color component block of the current block from a plurality of blocks obtained by partitioning the first color component region may include: selecting a target block from the plurality of blocks obtained by partitioning the first color component region, as the first color component block of the current block.

In a specific embodiment, the method may further include: selecting a block at a center location in the first color component region as the target block; selecting a block at a top-left corner in the first color component region as the target block; or selecting a block at a bottom-right corner in the first color component region as the target block.

It should be understood that in embodiments of this application, the target block serving as the first color component block may be a block at any location in the plurality of blocks shown in FIG. 3, for example, a block at a center location in the co-located luma region (the block filled with black) as shown in FIG. 3, a block at a top-left corner in the co-located luma region (the block filled with black) as shown in FIG. 7, a block at a bottom-right corner in the co-located luma region (the block filled with black) as shown in FIG. 8, a block at a top-right corner in the co-located luma region, a block at a bottom-left corner in the co-located luma region, or even a block at a center location in a top-left region, or the like, which is not specifically limited here.

Further, in some embodiments, the process of determining the first color component block of the current block from a plurality of blocks obtained by partitioning the first color component region may include: determining at least one candidate block at a preset location from the plurality of blocks obtained by partitioning the first color component region; and acquiring the at least one candidate block according to a preset order and performing mode determination on the at least one candidate block; and in a case that it is determined that the IBC mode is used for the first candidate block, using the first candidate block as the first color component block of the current block.

Further, in some embodiments, the process of determining the first color component block of the current block from a plurality of blocks obtained by partitioning the first color component region may include: determining at least one candidate block at a preset location from the plurality of blocks obtained by partitioning the first color component region, and determining that the at least one candidate block is the first color component block of the current block.

It should be understood that, in embodiments of this application, there may be one or more first color component blocks of the current block, which is not specifically limited. The first color component block may alternatively be determined by performing mode determination on the at least one candidate block at the preset location, specifically as shown in FIG. 9.

It should also be understood that in embodiments of this application, candidate blocks at the five locations shown in FIG. 9 may be acquired according to a preset order until a candidate block of which the prediction mode is the IBC mode is determined, that is, until it is found that the prediction mode of the CU at the first luma pixel location is the IBC mode, and the CU at the first luma pixel location is used as the corresponding luma block of the current block.

In S1702, in a case that a prediction mode of the first color component block is an IBC mode, a first block vector parameter of the first color component block is determined.

It should be noted that in embodiments of this application, after the first color component block is determined, it is necessary to determine a prediction mode of the first color component block. If the prediction mode of the first color component block is the IBC mode, it is necessary to further determine the first block vector parameter of the first color component block.

It should also be noted that in embodiments of this application, if there are a plurality of first color component blocks, the first block vector parameter may also be obtained by averaging BVs of the plurality of first color component blocks. Therefore, in some embodiments, for the at least one candidate block at the preset location, the process of determining a first block vector parameter of the first color component block in a case that a prediction mode of the first color component block is an IBC mode may include: determining at least one target block for which the IBC mode is used from the at least one candidate block, and determining a first block vector parameter of each of the at least one target block; and calculating an average of the first block vector parameters of all of the at least one target block, as the first block vector parameter of the first color component block.

It should be understood that, in embodiments of this application, the first color component block of the current block is not limited to one block here, and may alternatively be composed of a plurality of blocks. When the first color component block consists of a plurality of blocks, prediction modes of the plurality of blocks are all the IBC mode. For example, a plurality of luma CUs in the co-located luma region are first acquired, and then an average of first block vector parameters of the plurality of luma CUs is calculated as the finally acquired first block vector parameter.

Further, in embodiments of this application, the finally acquired first block vector parameter may be determined by selecting an optimal block vector parameter through template matching. Therefore, in some embodiments, the method may further include: determining at least one target block for which the IBC mode is used from the at least one candidate block; and performing searching on the at least one target block using a template matching manner, to determine an optimal block vector parameter, as the first block vector parameter of the first color component block.

It should also be understood that, in embodiments of this application, for the first color component block of the current block, after the plurality of luma CUs in the co-located luma region are acquired, the optimal block vector parameter is selected in a template matching manner, as the finally acquired first block vector parameter.

It should also be noted that in embodiments of this application, after the first color component block is determined, it is necessary to determine a prediction mode of the first color component block. If the prediction mode of the first color component block is the IBC mode, the process shown in FIG. 17 continues to be performed, that is, it is necessary to determine the first block vector parameter of the first color component block. If the prediction mode of the first color component block is not the IBC mode, the process shown in FIG. 17 is not performed, and prediction may be performed on the second color component of the current block using a first preset mode, to determine a predicted value for the second color component of the current block. The first preset mode includes at least one of: a planar mode, a DM mode, a DC mode, a CCLM mode, or a skip mode, but is not limited thereto.

In S1703, a target block vector parameter of the second color component of the current block is determined based on the first block vector parameter of the first color component block.

It should be noted that, in embodiments of this application, the process of determining the target block vector parameter of the current block may include: using the first block vector parameter of the first color component block as the target block vector parameter of the current block; or adjusting the first block vector parameter of the first color component block to determine the target block vector parameter of the current block.

In a possible implementation, the process of adjusting the first block vector parameter of the first color component block to determine the target block vector parameter of the current block may include: determining a color sampling format for the current block; and performing scaling on the first block vector parameter of the first color component block based on the color sampling format, to determine the target block vector parameter of the current block.

In another possible implementation, the process of adjusting the first block vector parameter of the first color component block to determine the target block vector parameter of the current block may include: performing scaling on the first block vector parameter of the first color component block based on the color sampling format, to obtain an initial block vector parameter of the current block; and modifying the initial block vector parameter of the current block to determine the target block vector parameter of the current block.

In another possible implementation, the process of adjusting the first block vector parameter of the first color component block to determine the target block vector parameter of the current block may include: directly determining the target block vector parameter of the current block based on the initial block vector parameter of the current block.

Further, in some embodiments, the process of modifying the initial block vector parameter of the current block to determine the target block vector parameter of the current block may include: determining a search region for the current block based on the initial block vector parameter of the current block and location information of the current block; and performing searching within the search region using a template matching manner, to determine an optimal block vector parameter, as the target block vector parameter of the current block.

For example, after chroma BV parameters scaled based on the color sampling format shown in Table 7 are obtained, the chroma BV parameters may be directly used, or may be modified. The modification here may include, but is not limited to, the following manner: modification is performed using an IntraTMP mode, that is, after the chroma BV parameters are obtained, an offset location is found based on a location of the current block and the obtained chroma BV parameters, a fine search is performed near the offset location using the template matching manner, to determine optimal chroma BV parameters, and the optimal chroma BV parameters are used as the finally obtained chroma BV parameters, that is, the target block vector parameter of the current block.

In S1704, IBC extension mode-based prediction is performed on the second color component of the current block by using the target block vector parameter, to determine a predicted value for the second color component of the current block.

It should be noted that in embodiments of this application, for the IBC extension mode (that is, the target prediction mode in embodiments of this application), prediction may be performed on the second color component of the current block based on the determined target block vector parameter, so as to determine the predicted value for the second color component of the current block.

It should also be noted that in embodiments of this application, after the target block vector parameter of the current block is obtained, it is necessary to determine whether the target block vector parameter is available, that is, whether the target block vector parameter meets an available condition. In some embodiments, the method may further include: after the target block vector parameter of the current block is determined, determining whether the target block vector parameter meets an available condition; and in a case that the target block vector parameter meets the available condition, performing IBC extension mode-based prediction on the second color component of the current block by using the target block vector parameter, to determine a predicted value for the second color component of the current block.

Specifically, in embodiments of this application, the IBC extension mode-based prediction can be performed on the second color component of the current block by using the target block vector parameter, only when the target block vector parameter meets the available condition, so as to determine the predicted value for the second color component of the current block.

Further, in some embodiments, whether the target block vector parameter meets the available condition may include at least:
whether an offset location indicated by the target block vector parameter does not exceed an image boundary;
whether an offset location indicated by the target block vector parameter does not overlap the current block;
whether an offset location indicated by the target block vector parameter does not exceed an available region for the IBC mode; and
whether an offset location indicated by the target block vector parameter has been reconstructed.

It should be understood that in embodiments of this application, only when the conditions above are all met, it can be determined that the target block vector parameter meets the available condition, that is, the target block vector parameter is available. In a specific embodiment, the target block vector parameter meeting the available condition includes at least: an offset location indicated by the target block vector parameter does not exceed an image boundary; an offset location indicated by the target block vector parameter does not overlap the current block; an offset location indicated by the target block vector parameter does not exceed an available region for the IBC mode; and an offset location indicated by the target block vector parameter has been reconstructed.

It should also be understood that in embodiments of this application, after scaling is performed on the first block vector parameter of the first color component block based on the color sampling format, it is necessary to modify the obtained initial block vector parameter. Before the modification is performed, the method may further include: determining whether the initial block vector parameter meets an available condition; and when the initial block vector parameter meets the available condition, modifying the initial block vector parameter of the current block to determine the target block vector parameter of the current block; or when the initial block vector parameter does not meet the available condition, adjusting the initial block vector parameter of the current block until the adjusted block vector parameter meets the available condition; and modifying the adjusted block vector parameter to determine the target block vector parameter of the current block.

It may also be understood that in embodiments of this application, at least one candidate block at a preset location is determined from the plurality of blocks obtained by partitioning the first color component region. The at least one candidate block is acquired according to a preset order and subjected to mode determination; and if it is determined that the IBC mode is used for the first candidate block, the first candidate block is used as the first color component block of the current block. In this process, it is necessary to determine whether BV parameters of the first candidate block meet the available condition, to determine whether it is necessary to perform mode determination on a next candidate block.

In some embodiments, the method may further include: in a case that it is determined that the IBC mode is used for the first candidate block, determining a first block vector parameter of the first candidate block; determining whether the first block vector parameter of the first candidate block meets an available condition; and in a case that the first block vector parameter of the first candidate block meets the available condition, using the first candidate block as the first color component block of the current block; or in a case that the first block vector parameter of the first candidate block does not meet the available condition, performing mode determination on a next candidate block, until a target candidate block for which the IBC mode is used and whose first block vector parameter meets the available condition is determined, wherein the target candidate block is used as the first color component block of the current block.

Further, in some embodiments, the method may further include: in a case that there is no target candidate block for which the IBC mode is used and whose first block vector parameter meets the available condition among the at least one candidate block, performing intra prediction on the second color component of the current block using a first preset mode, to determine the predicted value for the second color component of the current block, where the first preset mode includes at least one of: a planar mode, a DM mode, a DC mode, a CCLM mode, or a skip mode.

For example, FIG. 9 is still used as an example. If there is one or more CUs for which the IBC mode is used among the CUs at the five locations, CUs at the five locations may be sequentially acquired again (until a first CU that meets the following conditions is found). In this case, not only whether the IBC mode is used for the CU is determined, but also luma BV parameters of the CU are adjusted, to determine BV parameters to be applied to the chroma. Then, whether the chroma BV parameters are available is determined. If the chroma BV parameters are available, the CU is selected as a luma block for final BV acquisition. If the chroma BV parameters are unavailable, no luma CU is acquired, where the first preset mode includes but not limited to the planar mode, the inter-component prediction mode, or other angular prediction modes, or even this mode may be skipped. Alternatively, a first CU for which the IBC mode is used is found, BVs of the first CU are adjusted until the CU is available, and the CU is selected as a luma block for final BV acquisition.

Further, in some embodiments, the process of performing IBC extension mode-based prediction on the second color component of the current block by using the target block vector parameter, to determine a predicted value for the second color component of the current block may include: determining an offset location of the current block based on the target block vector parameter and location information of the current block; performing block copying based on the offset location of the current block, to obtain a first predicted block; and determining the predicted value for the second color component of the current block based on the first predicted block.

Further, in some embodiments, the process of determining the predicted value for the second color component of the current block based on the first predicted block may include: performing modification on the first predicted block to determine the predicted value for the second color component of the current block.

In a specific embodiment, the process of determining the predicted value for the second color component of the current block based on the first predicted block may include: performing intra prediction on the second color component of the current block using a second preset mode, to obtain a second predicted block; and performing weighted fusion on the first predicted block and the second predicted block to determine the predicted value for the second color component of the current block, where the second preset mode includes at least one of: a planar mode, a DM mode, a DC mode, or a CCLM mode.

It should be understood that in embodiments of this application, if the predicted value for the second color component of the current block is obtained by block copying based on the target block vector parameter, the predicted value may be modified in a manner such as performing weighting based on a conventional prediction mode.

It may also be understood that in some embodiments, the method may further include: determining a value for first syntax element identity information; encoding the value for the first syntax element identity information, and writing the encoded value into a bitstream.

In a specific embodiment, the process of determining a value for first syntax element identity information may include: in a case that the first syntax element identity information indicates that the IBC extension mode is enabled for the second color component of the current block, determining that the value for the first syntax element identity information is a first value; and in a case that the first syntax element identity information indicates that the IBC extension mode is disabled for the second color component of the current block, determining that the value for the first syntax element identity information is a second value.

It should be understood that in embodiments of this application, the first syntax element identity information may be represented by IbcEnabled or chromaIbcExMode Enabled, to indicate whether the IBC extension mode is enabled for the second color component of the current block. In other words, the first syntax element identity information may be used to indicate whether a target prediction mode (i.e., INTRA_DBV mode) is enabled for the second color component of the current block.

It should also be understood that in embodiments of this application, the first value is different from the second value, and the first value and the second value may be in a parametric form or numeric form. Specifically, the first syntax element identity information may be a parameter described in the profile or a value of a flag, which is not specifically limited here. For example, the first value may be set to 1, and the second value may be set to 0, but this is not specifically limited.

In this way, the encoding side encodes and writes the first syntax element identity information into a bitstream, and the decoding side may directly determine the value for the first syntax element identity information by decoding, to further determine whether the IBC extension mode is enabled for the second color component of the current block.

Further, in some embodiments, the method may further include: in a case that the first syntax element identity information indicates that the IBC extension mode is enabled for the second color component of the current block, determining a value for second syntax element identity information; and encoding the value for the second syntax element identity information, and writing the encoded value into a bitstream.

In a specific embodiment, the process of determining a value for second syntax element identity information may include: in a case that the second syntax element identity information indicates that the target prediction mode is used for the second color component of the current block, determining that the value for the second syntax element identity information is a first value; and in a case that the second syntax element identity information indicates that the target prediction mode is not used for the second color component of the current block, determining that the value for the second syntax element identity information is a second value.

Further, in some embodiments, the method may further include: determining a value for third syntax element identity information; and encoding the value for the third syntax element identity information, and writing the encoded value into a bitstream.

In a specific embodiment, the process of determining a value for third syntax element identity information may include: in a case that the third syntax element identity information indicates that the IBC mode is enabled for a current image, determining that the value for the third syntax element identity information is a first value; and in a case that the third syntax element identity information indicates that the IBC mode is disabled for a current image, determining that the value for the third syntax element identity information is a second value.

It should be understood that in embodiments of this application, the the value for the first syntax element identity information may be determined as follows. The first syntax element identity information may be used as a syntax element transmitted in the bitstream, and the value may be directly determined by decoding the bitstream. Alternatively, the first syntax element identity information may be used as a syntax element that is not transmitted in a bitstream, and in this case, the value may be determined based on the third syntax element identity information and whether the current block meets a preset condition.

In some embodiments, the process of determining a value for first syntax element identity information may include: in a case that the value for the third syntax element identity information is a first value and the current block meets a preset condition, determining that the value for the first syntax element identity information is the first value; and in a case that the value for the third syntax element identity information is a second value, determining that the value for the first syntax element identity information is the second value.

It should also be noted that, in embodiments of this application, the current block meeting the preset condition may include at least: a slice type of the current block is an I-frame; and a size of the current block meets a requirement of a preset upper limit.

In addition, in embodiments of this application, the second syntax element identity information may be represented by intra_dbv_flag or intra_chroma_ibc_flag, to indicate whether the target prediction mode is used for the second color component of the current block. The third syntax element identity information may be represented by sps_ibc_enabled_flag, to indicate whether the IBC mode is enabled for the current image. Here, the current image includes the current block.

In embodiments of this application, the first value is different from the second value, and the first value and the second value may be in a parametric form or numeric form. Specifically, the first syntax element identity information, the second syntax element identity information, the third syntax element identity information, or the like may be a parameter described in the profile, or may be value of a flag, which is not specifically limited here.

For example, setting the first value to 1 and the second value to 0 is used as an example. If the value of sps_ibc_enabled_flag is equal to 0, the value of IbcEnabled is equal to 0. If the value of sps_ibc_enabled_flag is equal to 1 and if the following conditions are all met (including but not limited to the following conditions), the value of IbcEnabled is equal to 1. These conditions may include but are not limited to: sh_slice_type is an I-frame; and CtbLog2SizeY is less than or equal to MaxChromaIbcSize.

In some embodiments, the method may further include: in a case that the second syntax element identity information indicates that the target prediction mode is not used for the second color component of the current block, determining a first intra prediction mode of the second color component of the current block; and performing intra prediction on the second color component of the current block using the first intra prediction mode, to determine the predicted value for the second color component of the current block.

Further, in some embodiments, the method may further include: determining a value for fourth syntax element identity information based on the first intra prediction mode of the second color component of the current block; and encoding the value for the fourth syntax element identity information, and writing the encoded value into a bitstream.

In embodiments of this application, the fourth syntax element identify information may be represented by intra_chroma_pred_mode, to indicate a chroma intra prediction mode used for the current block. For example, in a case in which intra_dbv_flag or intra_chroma_ibc_flag is equal to 0, the target prediction mode is no longer used, and chroma prediction is performed on the current block using the chroma intra prediction mode indicated by intra_chroma_pred_mode, to determine the chroma predicted value for the current block.

For adding a syntax element, in some embodiments, the method may further include: determining a second intra prediction mode of the second color component of the current block in a case that the first syntax element identity information indicates that the IBC extension mode is enabled for the second color component of the current block, and performing intra prediction on the second color component of the current block using the second intra prediction mode, to determine the predicted value for the second color component of the current block; and determining a third intra prediction mode of the second color component of the current block in a case that the first syntax element identity information indicates that the IBC extension mode is disabled for the second color component of the current block, and performing intra prediction on the second color component of the current block using the third intra prediction mode, to determine the predicted value for the second color component of the current block, where the second intra prediction mode includes the target prediction mode, and the third intra prediction mode does not include the target prediction mode.

Further, in some embodiments, the method may further include: determining a value for fifth syntax element identity information based on the second intra prediction mode of the second color component of the current block; performing binarization on the value for the fifth syntax element identity information using a first preset binary mapping table, to determine at least one character corresponding to the fifth syntax element identity information; and encoding the at least one character corresponding to the fifth syntax element identity information, and writing the encoded character into a bitstream.

Further, in some embodiments, the method may further include: determining a value for sixth syntax element identity information using the third intra prediction mode of the second color component of the current block; performing binarization on the value for the sixth syntax element identity information using a second preset binary mapping table, to determine at least one character corresponding to the sixth syntax element identity information; and encoding the at least one character corresponding to the sixth syntax element identity information, and writing the encoded character into a bitstream.

In embodiments of this application, the fifth syntax element identity information may be represented by intra_chroma_pred_mode_add, and the sixth syntax element identity information may be represented by intra_chroma_pred_mode, where intra_chroma_pred_mode_add is used to indicate that the INTRA_DBV mode is added and intra_chroma_pred_mode represents a chroma prediction mode in the related technology.

In embodiments of this application, a binarization process of the fifth syntax element identity information is different from a binarization process of the sixth syntax element identity information, that is, the binary mapping tables used for the fifth and sixth syntax element identity information are different. For example, the first preset binary mapping table may be as shown in Table 20, and the second preset binary mapping table may be as shown in Table 21, which is not specifically limited.

For maintaining a syntax element, in some embodiments, the method may further include:
in a case that the first syntax element identity information indicates that the IBC extension mode is enabled for the second color component of the current block, performing binarization on a value for the second syntax element identity information using a first preset binary mapping table, to determine at least one character corresponding to the second syntax element identity information; and encoding the at least one character corresponding to the second syntax element identity information, and writing the encoded character into a bitstream;
   or
   in a case that the first syntax element identity information indicates that the IBC extension mode is disabled for the second color component of the current block, performing binarization on a value for the second syntax element identity information using a second preset binary mapping table, to determine at least one character corresponding to the second syntax element identity information; and encoding the at least one character corresponding to the second syntax element identity information, and writing the encoded character into a bitstream.

In embodiments of this application, the second syntax element identity information may be represented by intra_chroma_pred_mode. That is, the syntax element intra_chroma_pred_mode is maintained. In this case, different binarization manners may be used depending on different values of IbcEnabled. For example, the first preset binary mapping table may be as shown in Table 25, and the second preset binary mapping table may be as shown in Table 26, which is not specifically limited.

Further, an embodiment of this application further provides a bitstream. The bitstream is generated by encoding information to be encoded, where the information to be encoded includes at least one of:
a target block vector parameter of a current block, a value for first syntax element identity information, a value for second syntax element identity information, a value for third syntax element identity information, a value for fourth syntax element identity information, a value for fifth syntax element identity information, or a value for sixth syntax element identity information.

It should be noted that, in embodiments of this application, for values of the first syntax element identity information, the second syntax element identity information, the third syntax element identity information, the fourth syntax element identity information, the fifth syntax element identity information, and the sixth syntax element identity information, the first value is different from the second value, and the first value and the second value may be in a parametric form or numeric form, for example, may be a parameter described in the profile or a value of a flag, which is not specifically limited here.

It should also be noted that, in embodiments of this application, the third syntax element identity information may be a syntax element at the SPS layer. When the IBC mode and dual-tree partitioning are enabled at the SPS layer, and if the prediction mode of the luma block is the IBC mode, BVs of the luma block are acquired, and the BVs are adjusted to be applied to the chroma, thereby solving the monotony problem in chroma prediction. In addition, the IBC algorithm is implicitly applied into chroma prediction, and the information of the co-located luma region is fully utilized, thereby effectively improving encoding efficiency.

It should also be noted that, in embodiments of this application, the encoding side may encode and write these syntax element identity information into a bitstream, and the decoding side may determine values of these syntax element identity information by decoding, to further determine whether the target prediction mode is used for the second color component of the current block, and chroma prediction is performed on the current block in a case in which the target prediction mode is used, thereby effectively improving decoding efficiency.

According to the encoding method provided in embodiments of this application, in a process of deriving a chroma prediction mode using a luma prediction mode, if the prediction mode of the luma block corresponding to the current block is the IBC mode, the target block vector parameter to be applied to the chroma component can be determined based on the block vector parameter of the luma block, and the IBC extension mode-based prediction is performed on the chroma component by using the target block vector parameter, to determine the chroma predicted value for the current block, so that a problem of monotony in chroma prediction is resolved, the IBC mode is implicitly applied into chroma prediction, and related information of the co-located luma block is fully utilized, thereby improving accuracy of chroma prediction, reducing a code rate, improving coding efficiency, and thus improving coding performance.

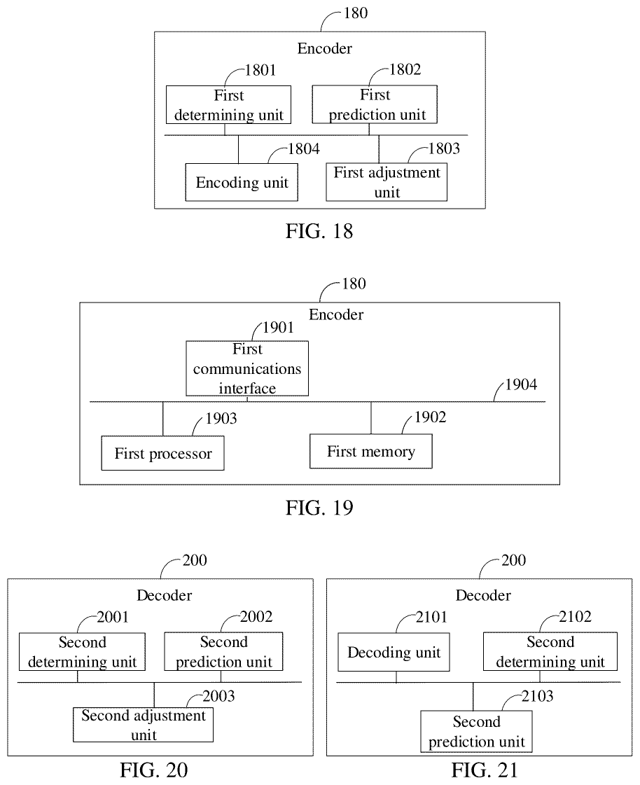

In still another embodiment of this application, reference is made to FIG. 18, which is a schematic diagram of a structure of an encoder according to an embodiment of this application. As shown in FIG. 18, the encoder 180 may include: a first determining unit 1801 and a first prediction unit 1802.

The first determining unit 1801 is configured to: in a case that a prediction mode of a second color component of a current block is a target prediction mode, determine a first color component block of the current block; and in a case that a prediction mode of the first color component block is an IBC mode, determine a first block vector parameter of the first color component block; and determine a target block vector parameter of the second color component of the current block based on the first block vector parameter of the first color component block.

The first prediction unit 1802 is configured to perform IBC extension mode-based prediction on the second color component of the current block by using the target block vector parameter, to determine a predicted value for the second color component of the current block.

In some embodiments, the first determining unit 1801 is further configured to determine a first color component region co-located with the current block; and determine the first color component block of the current block from a plurality of blocks obtained by partitioning the first color component region.

In some embodiments, the first determining unit 1801 is further configured to select a target block from the plurality of blocks obtained by partitioning the first color component region, as the first color component block of the current block.

In some embodiments, the first determining unit 1801 is further configured to: select a block at a center location in the first color component region as the target block; select a block at a top-left corner in the first color component region as the target block; or select a block at a bottom-right corner in the first color component region as the target block.

In some embodiments, the first determining unit 1801 is further configured to determine at least one candidate block at a preset location from the plurality of blocks obtained by partitioning the first color component region; acquire the at least one candidate block according to a preset order and perform mode determination on the at least one candidate block; and in a case that it is determined that the IBC mode is used for the first candidate block among the at least one candidate block, use the first candidate block as the first color component block of the current block.

In some embodiments, the first determining unit 1801 is further configured to determine at least one candidate block at a preset location from the plurality of blocks obtained by partitioning the first color component region, and determine the at least one candidate block as the first color component block of the current block.

Accordingly, the first determining unit 1801 is further configured to determine at least one target block for which the IBC mode is used from the at least one candidate block, and determine a first block vector parameter of each of the at least one target block; and calculate an average of the first block vector parameters of all of the at least one target block, as the first block vector parameter of the first color component block.

In some embodiments, the first determining unit 1801 is further configured to determine at least one target block for which the IBC mode is used from the at least one candidate block; and perform searching on the at least one target block using a template matching manner, to determine an optimal block vector parameter, as the first block vector parameter of the first color component block.

In some embodiments, referring to FIG. 18, the encoder 180 may further include a first adjustment unit 1803, configured to adjust the first block vector parameter of the first color component block to determine the target block vector parameter of the current block.

In some embodiments, the first determining unit 1801 is further configured to determine a color sampling format for the current block.

The first adjustment unit 1803 is further configured to perform scaling on the first block vector parameter of the first color component block based on the color sampling format, to determine the target block vector parameter of the current block.

In some embodiments, the first adjustment unit 1803 is configured to perform scaling on the first block vector parameter of the first color component block based on the color sampling format, to obtain an initial block vector parameter of the current block; and modify the initial block vector parameter of the current block to determine the target block vector parameter of the current block.

In some embodiments, the first adjustment unit 1803 is further configured to directly determine the target block vector parameter of the current block based on the initial block vector parameter of the current block.

In some embodiments, the first adjustment unit 1803 is further configured to determine a search region for the current block based on the initial block vector parameter of the current block and location information of the current block; and perform searching within the search region using a template matching manner, to determine an optimal block vector parameter, as the target block vector parameter of the current block.

In some embodiments, the first prediction unit 1802 is further configured to: after the target block vector parameter of the current block is determined, determine whether the target block vector parameter meets an available condition; and in a case that the target block vector parameter meets the available condition, perform IBC extension mode-based prediction on the second color component of the current block by using the target block vector parameter, to determine a predicted value for the second color component of the current block.

In some embodiments, the target block vector parameter meeting the available condition includes at least: an offset location indicated by the target block vector parameter does not exceed an image boundary; an offset location indicated by the target block vector parameter does not overlap the current block; an offset location indicated by the target block vector parameter does not exceed an available region for the IBC mode; and an offset location indicated by the target block vector parameter has been reconstructed.

In some embodiments, the first determining unit 1801 is further configured to: in a case that it is determined that the IBC mode is used for the first candidate block, determine a first block vector parameter of the first candidate block; determine whether the first block vector parameter of the first candidate block meets an available condition; in a case that the first block vector parameter of the first candidate block meets the available condition, use the first candidate block as the first color component block of the current block; and in a case that the first block vector parameter of the first candidate block does not meet the available condition, perform mode determination on a next candidate block, until a target candidate block for which the IBC mode is used and whose first block vector parameter meets the available condition is determined, where the target candidate block is used as the first color component block of the current block.

In some embodiments, the first prediction unit 1802 is further configured to: in a case that there is no target candidate block for which the IBC mode is used and whose first block vector parameter meets the available condition among the at least one candidate block, perform intra prediction on the second color component of the current block using a first preset mode, to determine the predicted value for the second color component of the current block, where the first preset mode includes at least one of: a planar mode, a DM mode, a DC mode, a CCLM mode, or a skip mode.

In some embodiments, the first prediction unit 1802 is further configured to: determine an offset location of the current block based on the target block vector parameter and location information of the current block; perform block copying based on the offset location of the current block, to obtain a first predicted block; and determine the predicted value for the second color component of the current block based on the first predicted block.

In some embodiments, the first prediction unit 1802 is further configured to perform modification on the first predicted block to determine the predicted value for the second color component of the current block.

In some embodiments, the first prediction unit 1802 is further configured to perform intra prediction on the second color component of the current block using a second preset mode, to obtain a second predicted block; and perform weighted fusion on the first predicted block and the second predicted block to determine the predicted value for the second color component of the current block, where the second preset mode includes at least one of: a planar mode, a DM mode, a DC mode, or a CCLM mode.

In some embodiments, referring to FIG. 18, the encoder 180 may further include an encoding unit 1804.

The first determining unit 1801 is further configured to determine a value for first syntax element identity information.

The encoding unit 1804 is configured to encode the value for the first syntax element identity information, and write the encoded value into a bitstream.

In some embodiments, the first determining unit 1801 is further configured to: in a case that the first syntax element identity information indicates that the IBC extension mode is enabled for the second color component of the current block, determine that the value for the first syntax element identity information is a first value; and in a case that the first syntax element identity information indicates that the IBC extension mode is disabled for the second color component of the current block, determine that the value for the first syntax element identity information is a second value.

In some embodiments, the first determining unit 1801 is further configured to: in a case that the first syntax element identity information indicates that the IBC extension mode is enabled for the second color component of the current block, determine a value for second syntax element identity information.

The encoding unit 1804 is further configured to encode the value for the second syntax element identity information, and write the encoded value into a bitstream.

In some embodiments, the first determining unit 1801 is further configured to: in a case that the second syntax element identity information indicates that the target prediction mode is used for the second color component of the current block, determine that the value for the second syntax element identity information is a first value; or in a case that the second syntax element identity information indicates that the target prediction mode is not used for the second color component of the current block, determine that the value for the second syntax element identity information is a second value.

In some embodiments, the first determining unit 1801 is further configured to determine a value for third syntax element identity information.

The encoding unit 1804 is further configured to encode the value for the third syntax element identity information, and write the encoded value into a bitstream.

In some embodiments, the first determining unit 1801 is further configured to: in a case that the value for the third syntax element identity information is a first value and the current block meets a preset condition, determine that the value for the first syntax element identity information is the first value; and in a case that the value for the third syntax element identity information is a second value, determine that the value for the first syntax element identity information is the second value.

In some embodiments, the current block meeting the preset condition includes at least: a slice type of the current block is an I-frame; and a size of the current block meets a requirement of a preset upper limit.

In some embodiments, the first determining unit 1801 is further configured to: in a case that the third syntax element identity information indicates that the IBC mode is enabled for a current image, determine that the value for the third syntax element identity information is a first value; and in a case that the third syntax element identity information indicates that the IBC mode is disabled for a current image, determine that the value for the third syntax element identity information is a second value.

In some embodiments, the first determining unit 1801 is further configured to: in a case that the second syntax element identity information indicates that the target prediction mode is not used for the second color component of the current block, determine a first intra prediction mode of the second color component of the current block.

The first prediction unit 1802 is further configured to perform intra prediction on the second color component of the current block using the first intra prediction mode, to determine the predicted value for the second color component of the current block.

In some embodiments, the first determining unit 1801 is further configured to determine a value for fourth syntax element identity information based on the first intra prediction mode of the second color component of the current block.

The encoding unit 1804 is further configured to encode the value for the fourth syntax element identity information, and write the encoded value into a bitstream.

In some embodiments, the first prediction unit 1802 is further configured to determine a second intra prediction mode of the second color component of the current block in a case that the first syntax element identity information indicates that the IBC extension mode is enabled for the second color component of the current block, and perform intra prediction on the second color component of the current block using the second intra prediction mode, to determine the predicted value for the second color component of the current block; or configured to determine a third intra prediction mode of the second color component of the current block in a case that the first syntax element identity information indicates that the IBC extension mode is disabled for the second color component of the current block, and perform intra prediction on the second color component of the current block using the third intra prediction mode, to determine the predicted value for the second color component of the current block, where the second intra prediction mode includes the target prediction mode, and the third intra prediction mode does not include the target prediction mode.

In some embodiments, the first determining unit 1801 is further configured to determine a value for fifth syntax element identity information based on the second intra prediction mode of the second color component of the current block.

The encoding unit 1804 is further configured to perform binarization on the value for the fifth syntax element identity information using a first preset binary mapping table, to determine at least one character corresponding to the fifth syntax element identity information; and encode the at least one character corresponding to the fifth syntax element identity information, and write the encoded character into a bitstream.

In some embodiments, the first determining unit 1801 is further configured to determine a value for sixth syntax element identity information using the third intra prediction mode of the second color component of the current block.

The encoding unit 1804 is further configured to perform binarization on the value for the sixth syntax element identity information using a second preset binary mapping table, to determine at least one character corresponding to the sixth syntax element identity information; and encode the at least one character corresponding to the sixth syntax element identity information, and write the encoded character into a bitstream.

In some embodiments, the encoding unit 1804 is further configured to: in a case that the first syntax element identity information indicates that the IBC extension mode is enabled for the second color component of the current block, perform binarization on a value for the second syntax element identity information using a first preset binary mapping table, to determine at least one character corresponding to the second syntax element identity information; and encode the at least one character corresponding to the second syntax element identity information, and write the encoded character into a bitstream; or configured to: in a case that the first syntax element identity information indicates that the IBC extension mode is disabled for the second color component of the current block, perform binarization on a value for the second syntax element identity information using a second preset binary mapping table, to determine at least one character corresponding to the second syntax element identity information; and encode the at least one character corresponding to the second syntax element identity information, and write the encoded character into a bitstream.

It may be understood that in embodiments of this application, the “unit” may be a partial circuit, a partial processor, a partial program or software, etc., or certainly, may be a module, or may be non-modular. In addition, component parts in the embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, the technical solutions of the embodiments essentially, or the part contributing to the conventional technology, or all or some of the technical solutions may be implemented in a form of a software product. The computer software product is stored in a storage medium and includes several instructions for instructing a computer device (which may be a personal computer, a server, a network device, or the like) or a processor to perform all or some of the steps of the methods described in the embodiments. The foregoing storage medium includes various media that may store a program code, such as a USB flash drive, a removable hard disk, a read-only memory (ROM), a random access memory (RAM), a magnetic disk, or an optical disk.

Therefore, an embodiment of this application provides a computer-readable storage medium, applied to an encoder 180. The computer-readable storage medium stores a computer program, and the computer program is executed by a first processor to implement the method according to any one of the foregoing embodiments.

Based on the composition of the encoder 180 and the computer-readable storage medium, reference is made to FIG. 19, which is a schematic diagram of a structure of specific hardware of the encoder 180 according to an embodiment of this application. As shown in FIG. 19, the encoder 180 may include a first communications interface 1901, a first memory 1902, and a first processor 1903. The components are coupled together by using a first bus system 1904. It may be understood that the first bus system 1904 is configured to implement connection and communication between these components. The first bus system 1904 may further include a power bus, a control bus, a status signal bus, and the like, in addition to a data bus. For clarity of description, various buses are marked as the first bus system 1904 in FIG. 19.

The first communications interface 1901 is configured to receive and transmit signals in a process of transmitting and receiving information with other external network elements.

The first memory 1902 is configured to store a computer program runnable on the first processor 1903.

The first processor 1903 is configured to run the computer program to perform the following operations:
in a case that a prediction mode of a second color component of a current block is a target prediction mode, determining a first color component block of the current block; in a case that a prediction mode of the first color component block is an IBC mode, determining a first block vector parameter of the first color component block; determining a target block vector parameter of the second color component of the current block based on the first block vector parameter of the first color component block; and performing IBC extension mode-based prediction on the second color component of the current block by using the target block vector parameter, to determine a predicted value for the second color component of the current block.

It may be understood that, in embodiments of this application, the first memory 1902 may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example rather than limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). The first memory 1902 in the systems and the methods described in this application include but are not limited to these memories and any memory of another appropriate type.

The first processor 1903 may be an integrated circuit chip and has a signal processing capability. In an implementation process, steps in the foregoing method can be implemented by using a hardware integrated logical circuit in the first processor 1903, or by using instructions in a form of software. The first processor 1903 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The methods, the steps, and logical block diagrams that are disclosed in embodiments of this application may be implemented or performed. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in the first memory 1902, and the first processor 1903 reads information in the first memory 1902 and completes the steps of the foregoing methods in combination with hardware of the first processor.

It may be understood that the embodiments described in this application can be implemented in hardware, software, firmware, middleware, microcode, or a combination thereof. For hardware implementation, the processing unit may be implemented in one or more application-specific integrated circuits (ASIC), digital signal processors (DSP), digital signal processing devices (DSP Device, DSPD), programmable logic devices (PLD), field programmable gate arrays (FPGA), general-purpose processors, controllers, microcontrollers, microprocessors, and other electronic units configured to perform the functions described in this application, or a combination thereof. For software implementation, the techniques described in this application can be implemented by modules (e.g., processes, functions, etc.) that perform the functions described in this application. Software code may be stored in a memory and executed by a processor. The memory can be implemented in or outside the processor.

Optionally, in another embodiment, the first processor 1903 is further configured to run the computer program to perform the method according to any one of the foregoing embodiments.

According to the encoder provided in this embodiment, in a process of determining a chroma prediction mode based on a luma prediction mode, if the prediction mode of the luma block corresponding to the current block is the IBC mode, the target block vector parameter to be applied to the chroma component can be determined based on the block vector parameter of the luma block, and the IBC extension mode-based prediction is performed on the chroma component by using the target block vector parameter, to determine the chroma predicted value for the current block, so that a problem of monotony in chroma prediction is resolved, the IBC mode is implicitly applied to chroma prediction, and related information of the co-located luma block is fully utilized, thereby improving accuracy of chroma prediction, reducing a code rate, improving encoding efficiency, and thus improving encoding performance.

In still another embodiment of this application, reference is made to FIG. 20, which is a schematic diagram of a structure of a decoder according to an embodiment of this application. As shown in FIG. 20, the decoder 200 may include: a second determining unit 2001 and a second prediction unit 2002.

The second determining unit 2001 is configured to: determine a first color component block of a current block, determine a first block vector parameter of the first color component block in a case that a prediction mode of the first color component block is an IBC mode, and determine a target block vector parameter of a second color component of the current block based on the first block vector parameter of the first color component block.

The second prediction unit 2002 is configured to perform IBC extension mode-based prediction on the second color component of the current block by using the target block vector parameter, to determine a predicted value for the second color component of the current block.

In some embodiments, the second determining unit 2001 is further configured to determine a first color component region co-located with the current block; and determine the first color component block of the current block from a plurality of blocks obtained by partitioning the first color component region.

In some embodiments, the second determining unit 2001 is further configured to select a target block from the plurality of blocks obtained by partitioning the first color component region, as the first color component block of the current block.

In some embodiments, the second determining unit 2001 is further configured to: select a block at a center location in the first color component region as the target block; select a block at a top-left corner in the first color component region as the target block; or select a block at a bottom-right corner in the first color component region as the target block.

In some embodiments, the second determining unit 2001 is further configured to: determine at least one candidate block at a preset location from the plurality of blocks obtained by partitioning the first color component region; acquire the at least one candidate block according to a preset order and perform mode determination on the at least one candidate block; and in a case that it is determined that the IBC mode is used for the first candidate block among the at least one candidate block, use the first candidate block as the first color component block of the current block.

In some embodiments, the second determining unit 2001 is further configured to determine at least one candidate block at a preset location from the plurality of blocks obtained by partitioning the first color component region, and determine the at least one candidate block as the first color component block of the current block.

Accordingly, the second determining unit 2001 is further configured to determine at least one target block for which the IBC mode is used from the at least one candidate block, and determine a first block vector parameter of each of the at least one target block; and calculate an average of the first block vector parameters of all of the at least one target block, as the first block vector parameter of the first color component block.

In some embodiments, the second determining unit 2001 is further configured to determine at least one target block for which the IBC mode is used from the at least one candidate block; and perform searching on the at least one target block using a template matching manner, to determine an optimal block vector parameter, as the first block vector parameter of the first color component block.

In some embodiments, referring to FIG. 20, the decoder 200 may further include a second adjustment unit 2003, configured to adjust the first block vector parameter of the first color component block to determine the target block vector parameter of the current block.

In some embodiments, the second determining unit 2001 is further configured to determine a color sampling format for the current block.

The second adjustment unit 2003 is further configured to perform scaling on the first block vector parameter of the first color component block based on the color sampling format, to determine the target block vector parameter of the current block.

In some embodiments, the second adjustment unit 2003 is further configured to perform scaling on the first block vector parameter of the first color component block based on the color sampling format, to obtain an initial block vector parameter of the current block; and modify the initial block vector parameter of the current block to determine the target block vector parameter of the current block.

In some embodiments, the second adjustment unit 2003 is further configured to directly determine the target block vector parameter of the current block based on the initial block vector parameter of the current block.

In some embodiments, the second prediction unit 2002 is further configured to: after the target block vector parameter of the current block is determined, determine whether the target block vector parameter meets an available condition; and in a case that the target block vector parameter meets the available condition, perform IBC extension mode-based prediction on the second color component of the current block by using the target block vector parameter, to determine a predicted value for the second color component of the current block.

In some embodiments, the target block vector parameter meeting the available condition includes at least: an offset location indicated by the target block vector parameter does not exceed an image boundary; an offset location indicated by the target block vector parameter does not overlap the current block; an offset location indicated by the target block vector parameter does not exceed an available region for the IBC mode; and an offset location indicated by the target block vector parameter has been reconstructed.

In some embodiments, the second determining unit 2001 is further configured to: in a case that it is determined that the IBC mode is used for the first candidate block, determine a first block vector parameter of the first candidate block; determine whether the first block vector parameter of the first candidate block meets an available condition; and in a case that the first block vector parameter of the first candidate block meets the available condition, use the first candidate block as the first color component block of the current block; or in a case that the first block vector parameter of the first candidate block does not meet the available condition, perform mode determination on a next candidate block, until a target candidate block for which the IBC mode is used and whose first block vector parameter meets the available condition is determined, where the target candidate block is used as the first color component block of the current block.

In some embodiments, the second prediction unit 2002 is further configured to: in a case that there is no target candidate block for which the IBC mode is used and whose first block vector parameter meets the available condition among the at least one candidate block, perform intra prediction on the second color component of the current block using a first preset mode, to determine the predicted value for the second color component of the current block, where the first preset mode includes at least one of: a planar mode, a DM mode, a DC mode, a CCLM mode, or a skip mode.

In some embodiments, the second prediction unit 2002 is further configured to: determine an offset location of the current block based on the target block vector parameter and location information of the current block; perform block copying based on the offset location of the current block, to obtain a first predicted block; and determine the predicted value for the second color component of the current block based on the first predicted block.

In some embodiments, the second prediction unit 2002 is further configured to perform modification on the first predicted block to determine the predicted value for the second color component of the current block.

In some embodiments, the second prediction unit 2002 is further configured to perform intra prediction on the second color component of the current block using a second preset mode, to obtain a second predicted block; and perform weighted fusion on the first predicted block and the second predicted block to determine the predicted value for the second color component of the current block, where the second preset mode includes at least one of: a planar mode, a DM mode, a DC mode, or a CCLM mode.

In still another embodiment of this application, reference is made to FIG. 21, which is a schematic diagram of a structure of another decoder according to an embodiment of this application. As shown in FIG. 21, the decoder 200 may include: a decoding unit 2101, a second determining unit 2102, and a second prediction unit 2103.

The second determining unit 2102 is configured to determine a value for first syntax element identity information.

The decoding unit 2101 is configured to: in a case that the first syntax element identity information indicates that an IBC extension mode is enabled for a second color component of a current block, decode a bitstream to determine a value for second syntax element identity information.

The second prediction unit 2103 is configured to: in a case that the second syntax element identity information indicates that a target prediction mode is used for the second color component of the current block, perform intra prediction on the second color component of the current block using the target prediction mode, to determine a predicted value for the second color component of the current block.

In some embodiments, the second determining unit 2102 is configured to: determine a first color component block of a current block, determine a first block vector parameter of the first color component block in a case that a prediction mode of the first color component block is an IBC mode, and determine a target block vector parameter of a second color component of the current block based on the first block vector parameter of the first color component block.

The second prediction unit 2103 is further configured to perform IBC extension mode-based prediction on the second color component of the current block by using the target block vector parameter, to determine a predicted value for the second color component of the current block.

In some embodiments, the decoding unit 2101 is further configured to decode a bitstream to determine a target block vector parameter of the current block.

The second prediction unit 2103 is further configured to perform IBC extension mode-based prediction on the second color component of the current block by using the target block vector parameter, to determine a predicted value for the second color component of the current block.

In some embodiments, the decoding unit 2101 is further configured to decode a bitstream to determine a value for third syntax element identity information.

The second determining unit 2102 is further configured to: in a case that the value for the third syntax element identity information is a first value and the current block meets a preset condition, determine that the value for the first syntax element identity information is the first value; and in a case that the value for the third syntax element identity information is a second value, determine that the value for the first syntax element identity information is the second value.

In some embodiments, the current block meeting the preset condition includes at least: a slice type of the current block is an I-frame; and a size of the current block meets a requirement of a preset upper limit.

In some embodiments, the second determining unit 2102 is further configured to: in a case that the value for the third syntax element identity information is the first value, determine that the third syntax element identity information indicates that an IBC mode is enabled for a current image; and in a case that the value for the third syntax element identity information is the second value, determine that the third syntax element identity information indicates that an IBC mode is disabled for a current image, where the current image includes the current block.

In some embodiments, the second determining unit 2102 is further configured to: in a case that the value for the first syntax element identity information is a first value, determine that the first syntax element identity information indicates that an IBC extension mode is enabled for the second color component of the current block; and in a case that the value for the first syntax element identity information is a second value, determine that the first syntax element identity information indicates that an IBC extension mode is disabled for the second color component of the current block.

In some embodiments, the second determining unit 2102 is further configured to: in a case that the value for the second syntax element identity information is a first value, determine that the second syntax element identity information indicates that a target prediction mode is used for the second color component of the current block; and in a case that the value for the second syntax element identity information is a second value, determine that the second syntax element identity information indicates that a target prediction mode is not used for the second color component of the current block.

In some embodiments, the decoding unit 2101 is further configured to: in a case that the value for the second syntax element identity information is the second value, decode a bitstream to determine a value for fourth syntax element identity information.

The second prediction unit 2103 is further configured to determine a first intra prediction mode of the second color component of the current block based on the value for the fourth syntax element identity information; and perform intra prediction on the second color component of the current block using the first intra prediction mode, to determine the predicted value for the second color component of the current block.

In some embodiments, the second prediction unit 2103 is further configured to: in a case that the first syntax element identity information indicates that the IBC extension mode is enabled for the second color component of the current block, decode a bitstream to determine a value for fifth syntax element identity information; and determine a second intra prediction mode of the second color component of the current block based on the value for the fifth syntax element identity information, and perform intra prediction on the second color component of the current block using the second intra prediction mode, to determine the predicted value for the second color component of the current block; or is configured to: in a case that the first syntax element identity information indicates that the IBC extension mode is disabled for the second color component of the current block, decode a bitstream to determine a value for sixth syntax element identity information; and determine a third intra prediction mode of the second color component of the current block based on the value for the sixth syntax element identity information, and perform intra prediction on the second color component of the current block using the third intra prediction mode, to determine the predicted value for the second color component of the current block, where the second intra prediction mode includes the target prediction mode, and the third intra prediction mode does not include the target prediction mode.

In some embodiments, the decoding unit 2101 is further configured to decode the bitstream to obtain at least one character corresponding to the fifth syntax element identity information; and map, using a first preset binary mapping table, the at least one character corresponding to the fifth syntax element identity information, to determine the value for the fifth syntax element identity information.

In some embodiments, the decoding unit 2101 is further configured to: decode the bitstream to obtain at least one character corresponding to the sixth syntax element identity information; and map, using a second preset binary mapping table, the at least one character corresponding to the sixth syntax element identity information, to determine the value for the sixth syntax element identity information.

In some embodiments, the second determining unit 2102 is further configured to: in a case that the first syntax element identity information indicates that the IBC extension mode is enabled for the second color component of the current block, decode a bitstream to obtain at least one character corresponding to the second syntax element identity information; and map, using a first preset binary mapping table, the at least one character corresponding to the second syntax element identity information, to determine the value for the second syntax element identity information; or is configured to: in a case that the first syntax element identity information indicates that the IBC extension mode is disabled for the second color component of the current block, decode a bitstream to obtain at least one character corresponding to the second syntax element identity information; and map, using a second preset binary mapping table, the at least one character corresponding to the second syntax element identity information, to determine the value for the second syntax element identity information.

In some embodiments, the second prediction unit 2103 is further configured to: in a case that the value for the second syntax element identity information is equal to a first preset constant value, determine that the second syntax element identity information indicates that the target prediction mode is not used for the second color component of the current block; after a fourth intra prediction mode of the second color component of the current block is determined, perform intra prediction on the second color component of the current block using the fourth intra prediction mode, to determine the predicted value for the second color component of the current block; or in a case that the value for the second syntax element identity information is equal to a second preset constant value, determine that the second syntax element identity information indicates that the target prediction mode is used for the second color component of the current block, and perform intra prediction on the second color component of the current block using the target prediction mode, to determine the predicted value for the second color component of the current block.

It may be understood that in the embodiments, the “unit” may be a partial circuit, a partial processor, a partial program or software, etc., or certainly, may be a module, or may be non-modular. In addition, component parts in the embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment of this application provides a computer-readable storage medium, applied to a decoder 200. The computer-readable storage medium stores a computer program, and the computer program is executed by a second processor to implement the method according to any one of the foregoing embodiments.

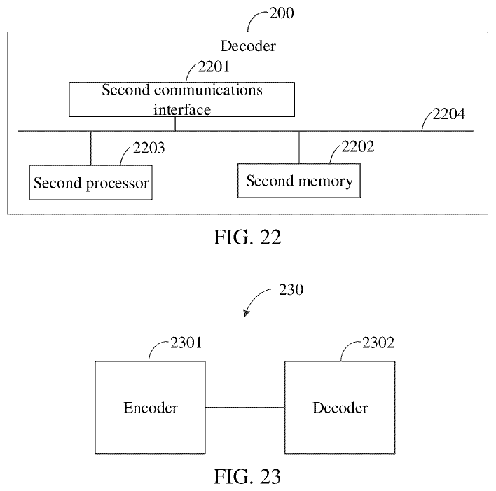

Based on the composition of the decoder 200 and the computer-readable storage medium, reference is made to FIG. 22, which is a schematic diagram of a structure of specific hardware of the decoder 200 according to an embodiment of this application. As shown in FIG. 22, the decoder 200 may include a second communications interface 2201, a second memory 2202, and a second processor 2203. The components are coupled together by using a second bus system 2204. It may be understood that the second bus system 2204 is configured to implement connection and communication between these components. The second bus system 2204 may further include a power bus, a control bus, a status signal bus, and the like, in addition to a data bus. For clarity of description, various buses are marked as the second bus system 2204 in FIG. 22.

The second communications interface 2201 is configured to receive and transmit signals in a process of transmitting and receiving information with other external network elements.

The second memory 2202 is configured to store a computer program runnable on the second processor 2203.

The second processor 2203 is configured to run the computer program to perform the following operations:
determining a first color component block of a current block; in a case that a prediction mode of the first color component block is an IBC mode, determining a first block vector parameter of the first color component block; determining a target block vector parameter of the second color component of the current block based on the first block vector parameter of the first color component block; and performing IBC extension mode-based prediction on the second color component of the current block by using the target block vector parameter, to determine a predicted value for the second color component of the current block.

Alternatively, the second processor 2203 is configured to run the computer program to perform the following operations:
determining a value for first syntax element identity information; in a case that the first syntax element identity information indicates that an IBC extension mode is enabled for a second color component of a current block, decoding a bitstream to determine a value for second syntax element identity information; in a case that the second syntax element identity information indicates that a target prediction mode is used for the second color component of the current block, performing intra prediction on the second color component of the current block using the target prediction mode, to determine a predicted value for the second color component of the current block.

Optionally, in another embodiment, the second processor 2203 is further configured to run the computer program to perform the method according to any one of the foregoing embodiments.

It may be understood that hardware functions of the second memory 2202 are similar to those of the first memory 1902, and hardware functions of the second processor 2203 are similar to those of the first processor 1903, which is not detailed here.

According to the decoder provided in this embodiment, in a process of determining a chroma prediction mode based on a luma prediction mode, if the prediction mode of the luma block corresponding to the current block is the IBC mode, the target block vector parameter to be applied to the chroma component can be determined based on the block vector parameter of the luma block, and the IBC extension mode-based prediction is performed on the chroma component by using the target block vector parameter, to determine the chroma predicted value for the current block, so that a problem of monotony in chroma prediction is resolved, the IBC mode is implicitly applied to chroma prediction, and related information of the co-located luma block is fully utilized, thereby improving accuracy of chroma prediction, reducing a code rate, improving coding efficiency, and thus improving coding performance.

In still another embodiment of this application, reference is made to FIG. 23, which is a schematic diagram of a structure of a coding system according to an embodiment of this application. As shown in FIG. 23, the coding system 230 may include an encoder 2301 and a decoder 2302.

In this embodiment of this application, the encoder 2301 may be the encoder according to any one of the foregoing embodiments, and the decoder 2302 may be the decoder according to any one of the foregoing embodiments.

It should be noted that in this application, the terminology “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a . . . ” does not exclude the existence of other identical elements in the process, method, item or device including this element.

The sequence numbers of the embodiments of this application are only for description, and do not represent superiority or inferiority of the embodiments.

The disclosed methods provided in the several method embodiments of this application may be randomly combined with each other without conflicts, to obtain new method embodiments.

The disclosed features provided in the several product embodiments of this application may be randomly combined with each other without conflicts, to obtain new product embodiments.

The disclosed features provided in the several method or device embodiments of this application may be randomly combined with each other without conflicts, to obtain new method embodiments or device embodiments.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

### INDUSTRIAL APPLICABILITY

In embodiments of this application, on an encoding side, in a case that a prediction mode of a second color component of a current block is a target prediction mode, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block. On a decoding side, a value for first syntax element identity information is determined; in a case that the first syntax element identity information indicates that an IBC extension mode is enabled for a second color component of a current block, a bitstream is decoded to determine a value for second syntax element identity information; in a case that the second syntax element identity information indicates that a target prediction mode is used for the second color component of the current block, a first color component block of the current block is determined; in a case that a prediction mode of the first color component block is an IBC mode, a first block vector parameter of the first color component block is determined; a target block vector parameter of the second color component of the current block is determined based on the first block vector parameter of the first color component block; and IBC extension mode-based prediction is performed on the second color component of the current block by using the target block vector parameter, to determine a predicted value for the second color component of the current block. In this way, according to the embodiments of this application, in a process of determining a chroma prediction mode based on a luma prediction mode, if a prediction mode of a luma block corresponding to a current block is an IBC mode, a target block vector parameter to be applied to a chroma component can be determined based on a block vector parameter of the luma block, and the IBC extension mode-based prediction is performed on the chroma component by using the target block vector parameter, to determine a chroma predicted value for the current block, so that a problem of monotony in chroma prediction is resolved, the IBC mode is implicitly applied to chroma prediction, and related information of the co-located luma block is fully utilized, thereby improving accuracy of chroma prediction, reducing a code rate, improving coding efficiency, and thus improving coding performance.

What is claimed is:

1. A decoding method, comprising:
determining a value for first syntax element identity information;
in a case that the first syntax element identity information indicates that an IBC extension mode is enabled for the second color component of the current block, decoding a bitstream to determine a value for second syntax element identity information; and
in a case that the second syntax element identity information indicates that a target prediction mode is used for the second color component of the current block, performing intra prediction on the second color component of the current block using the target prediction mode, to determine a predicted value for the second color component of the current block.

2. The method according to claim 1, wherein the target prediction mode is determined by:
determining a first color component block of a current block;
determining a first block vector parameter of the first color component block in a case that a prediction mode of the first color component block is an IBC mode;
determining a target block vector parameter of a second color component of the current block based on the first block vector parameter of the first color component block; and
performing IBC extension mode-based prediction on the second color component of the current block by using the target block vector parameter, to determine a predicted value for the second color component of the current block.

3. The method according to claim 2, wherein the determining a first color component block of a current block comprises:
determining a first color component region co-located with the current block; and
determining the first color component block of the current block from a plurality of blocks obtained by partitioning the first color component region;
wherein the determining the first color component block of the current block from a plurality of blocks obtained by partitioning the first color component region comprises:
selecting a target block from the plurality of blocks obtained by partitioning the first color component region, as the first color component block of the current block.

4. The method according to claim 3, wherein the determining the first color component block of the current block from a plurality of blocks obtained by partitioning the first color component region comprises:
determining at least one candidate block at a preset location from the plurality of blocks obtained by partitioning the first color component region; and
acquiring the at least one candidate block according to a preset order and performing mode determination on the at least one candidate block; and in a case that it is determined that the IBC mode is used for a first candidate block among the at least one candidate block, using the first candidate block as the first color component block of the current block.

5. The method according to claim 3, wherein the determining the first color component block of the current block from a plurality of blocks obtained by partitioning the first color component region comprises:
determining at least one candidate block at a preset location from the plurality of blocks obtained by partitioning the first color component region, and determining the at least one candidate block as the first color component block of the current block.

6. The method according to claim 5, wherein the determining a first block vector parameter of the first color component block in a case that a prediction mode of the first color component block is an IBC mode comprises:
determining at least one target block for which the IBC mode is used from the at least one candidate block, and determining a first block vector parameter of each of the at least one target block;
calculating an average of the first block vector parameters of all of the at least one target block, as the first block vector parameter of the first color component block; and
performing searching on the at least one target block using a template matching manner, to determine an optimal block vector parameter, as the first block vector parameter of the first color component block.

7. The method according to claim 2, wherein the determining a target block vector parameter of a second color component of the current block based on the first block vector parameter of the first color component block comprises:
adjusting the first block vector parameter of the first color component block to determine the target block vector parameter of the second color component of the current block.

8. The method according to claim 7, wherein the adjusting the first block vector parameter of the first color component block to determine the target block vector parameter of the current block comprises:
determining a color sampling format for the current block; and
performing scaling on the first block vector parameter of the first color component block based on the color sampling format, to determine the target block vector parameter of the current block.

9. The method according to claim 8, wherein the adjusting the first block vector parameter of the first color component block to determine the target block vector parameter of the current block further comprises:
performing scaling on the first block vector parameter of the first color component block based on the color sampling format, to obtain an initial block vector parameter of the current block; and
modifying the initial block vector parameter of the current block to determine the target block vector parameter of the current block;
or directly determining the target block vector parameter of the current block based on the initial block vector parameter of the current block.

10. The method according to claim 2, further comprising:
after the target block vector parameter of the current block is determined, determining whether the target block vector parameter meets an available condition; and
in a case that the target block vector parameter meets the available condition, performing IBC extension mode-based prediction on the second color component of the current block by using the target block vector parameter, to determine a predicted value for the second color component of the current block.

11. The method according to claim 2, wherein the performing IBC extension mode-based prediction on the second color component of the current block by using the target block vector parameter, to determine a predicted value for the second color component of the current block comprises:
determining an offset location of the current block based on the target block vector parameter and location information of the current block;
performing block copying based on the offset location of the current block, to obtain a first predicted block; and
determining the predicted value for the second color component of the current block based on the first predicted block.

12. The method according to claim 11, wherein the determining the predicted value for the second color component of the current block based on the first predicted block comprises:
determining the first predicted block as the predicted value for the second color component of the current block;
or
performing modification on the first predicted block to determine the predicted value for the second color component of the current block;
or
performing intra prediction on the second color component of the current block using a second preset mode, to obtain a second predicted block; and
performing weighted fusion on the first predicted block and the second predicted block to determine the predicted value for the second color component of the current block,
wherein the second preset mode comprises at least one of: a planar mode, a DM mode, a DC mode, or a CCLM mode.

13. The method according to claim 1, wherein the performing intra prediction on the second color component of the current block using the target prediction mode, to determine a second color component block for the current block comprises:
determining a first color component block of the current block;
determining a first block vector parameter of the first color component block in a case that a prediction mode of the first color component block is an IBC mode, and determining a target block vector parameter of the second color component of the current block based on the first block vector parameter of the first color component block; and
performing IBC extension mode-based prediction on the second color component of the current block by using the target block vector parameter, to determine a predicted value for the second color component of the current block.

14. The method according to claim 1, wherein the performing intra prediction on the second color component of the current block using the target prediction mode, to determine a second color component block for the current block comprises:
decoding a bitstream to determine a target block vector parameter of the current block; and
performing IBC extension mode-based prediction on the second color component of the current block by using the target block vector parameter, to determine a predicted value for the second color component of the current block.

15. The method according to claim 1, wherein the determining a value for first syntax element identity information comprises:
decoding a bitstream to determine a value for third syntax element identity information;
in a case that the value for the third syntax element identity information is a first value and the current block meets a preset condition, determining that the value for the first syntax element identity information is the first value; and
in a case that the value for the third syntax element identity information is a second value, determining that the value for the first syntax element identity information is the second value;
in a case that the value for the third syntax element identity information is the first value, determining that the third syntax element identity information indicates that an IBC mode is enabled for a current image; and
in a case that the value for the third syntax element identity information is the second value, determining that the third syntax element identity information indicates that an IBC mode is disabled for a current image,
wherein the current image comprises the current block;
wherein the current block meeting a preset condition comprises at least:
a slice type of the current block is an I-frame; and
a size of the current block meets a requirement of a preset upper limit.

16. The method according to claim 1, further comprising:
in a case that the value for the first syntax element identity information is a first value, determining that the first syntax element identity information indicates that an IBC extension mode is enabled for the second color component of the current block; and
in a case that the value for the first syntax element identity information is a second value, determining that the first syntax element identity information indicates that an IBC extension mode is disabled for the second color component of the current block.

17. The method according to claim 1, further comprising:
in a case that the value for the second syntax element identity information is a first value, determining that the second syntax element identity information indicates that a target prediction mode is used for the second color component of the current block;
in a case that the value for the second syntax element identity information is a second value, determining that the second syntax element identity information indicates that a target prediction mode is not used for the second color component of the current block;
in a case that the value for the second syntax element identity information is the second value, decoding a bitstream to determine a value for fourth syntax element identity information;
determining a first intra prediction mode of the second color component of the current block based on the value for the fourth syntax element identity information; and
performing intra prediction on the second color component of the current block using the first intra prediction mode, to determine the predicted value for the second color component of the current block.

18. The method according to claim 1, further comprising:
in a case that the first syntax element identity information indicates that the IBC extension mode is enabled for the second color component of the current block, decoding a bitstream to determine a value for fifth syntax element identity information; and determining a second intra prediction mode of the second color component of the current block based on the value for the fifth syntax element identity information, and performing intra prediction on the second color component of the current block using the second intra prediction mode, to determine the predicted value for the second color component of the current block,
in a case that the first syntax element identity information indicates that the IBC extension mode is disabled for the second color component of the current block, decoding a bitstream to determine a value for sixth syntax element identity information; and determining a third intra prediction mode of the second color component of the current block based on the value for the sixth syntax element identity information, and performing intra prediction on the second color component of the current block using the third intra prediction mode, to determine the predicted value for the second color component of the current block,
wherein the second intra prediction mode comprises the target prediction mode, and the third intra prediction mode does not comprise the target prediction mode.

19. An encoding method, comprising:
in a case that a prediction mode of a second color component of a current block is a target prediction mode, determining a first color component block of the current block;
in a case that a prediction mode of the first color component block is an BC mode, determining a first block vector parameter of the first color component block;
determining a target block vector parameter of the second color component of the current block based on the first block vector parameter of the first color component block; and
performing BC extension mode-based prediction on the second color component of the current block by using the target block vector parameter, to determine a predicted value for the second color component of the current block;
wherein the target prediction mode is determined by:
determining a first color component block of a current block;
determining a first block vector parameter of the first color component block in a case that a prediction mode of the first color component block is an BC mode;
determining a target block vector parameter of a second color component of the current block based on the first block vector parameter of the first color component block; and
performing BC extension mode-based prediction on the second color component of the current block by using the target block vector parameter, to determine a predicted value for the second color component of the current block.

20. A decoder, comprising a memory and a processor, wherein the memory is configured to store a computer program, and the processor is configured to execute the computer program stored in the memory to cause the decoder to perform a method comprising operations of:
determining a value for first syntax element identity information;
in a case that the first syntax element identity information indicates that an IBC extension mode is enabled for a second color component of a current block, decoding a bitstream to determine a value for second syntax element identity information; and
in a case that the second syntax element identity information indicates that a target prediction mode is used for the second color component of the current block, performing intra prediction on the second color component of the current block using the target prediction mode, to determine a predicted value for the second color component of the current block;
wherein the target prediction mode is determined by:
determining a first color component block of a current block;
determining a first block vector parameter of the first color component block in a case that a prediction mode of the first color component block is an IBC mode;
determining a target block vector parameter of a second color component of the current block based on the first block vector parameter of the first color component block; and
performing IBC extension mode-based prediction on the second color component of the current block by using the target block vector parameter, to determine a predicted value for the second color component of the current block.
